(19) United States
(12) Patent Application Publication
(10) Pub. No.: US 2010/0302595 A1
(43) Pub. Date: Dec. 2, 2010

(54) Image Reproducing Apparatus And Imaging Apparatus

(75) Inventors: Akihiko Yamada, Osaka (JP); Yasuhiro Iijima, Osaka (JP); Kazuhiro Kojima, Higashiosaka City (JP)

Correspondence Address: NDQ&M WATCHSTONE LLP, 300 NEW JERSEY AVENUE, NW, FIFTH FLOOR, WASHINGTON, DC, 20001, US

(73) Assignee: SANYO ELECTRIC CO., LTD., Osaka (JP)

(21) Appl. No.: 12/787,860

(22) Filed: May 26, 2010

(30) Foreign Application Priority Data
May 26, 2009 (JP) 2009-126525
Apr. 9, 2010 (JP) 2010-090207

(51) Int. Cl. G06K 9/00; G06K 15/02

(52) U.S. Cl. 358/1.18; 382/181

(57) ABSTRACT

An image reproducing apparatus includes a reproduction control unit which selects n out of given m input images as n output images by evaluating similarity among different input images of the m input images, and outputs the n output images onto a reproduction medium (m is an integer of two or larger, n is an integer of one or larger, and m>n holds).

### CROSS-REFERENCE TO RELATED APPLICATIONS

This nonprovisional application claims priority under 35 U.S.C. §119(a) on Patent Application No. 2009-126525 filed in Japan on May 26, 2009 and on Patent Application No. 2010-090207 filed in Japan on Apr. 9, 2010, the entire contents of which are hereby incorporated by reference.

### BACKGROUND OF THE INVENTION

1. Field of the Invention

The present invention relates to an image reproducing apparatus, and an imaging apparatus such as a digital camera having the image reproducing apparatus.

2. Description of Related Art

As a reproducing method of a plurality of input images, there are a slide show reproduction method and a thumbnail display reproduction method. In the slide show reproduction method, the input images as reproduction objects are displayed sequentially one by one at a constant time interval. In the thumbnail display reproduction method, a plurality of thumbnails of a plurality of input images are arranged vertically and/or horizontally and are displayed simultaneously.

Along with an increase in recording capacity of a recording medium in recent years, a user may perform image sensing of digital images freely and sequentially, so that many similar images are taken in a short time (e.g., image sensing of the same person with the same landscape as background may be performed many times in substantially the same frame composition). In this case, if reproduction of the recorded images is performed by the slide show reproduction, similar images may be displayed sequentially so that contents of the display become redundant. In addition, time necessary for reproduction is increased. The same is true for reproduction by the thumbnail display.

In addition, for example, there is the case where 20 target images obtained by image sensing of similar landscapes are recorded in the recording medium, and the tenth target image among the 20 target images is an image that is most important for the user (e.g., an image with best focus). In this case, if many recorded images (e.g., a hundred recorded images) including the 20 target images are simply displayed on the display screen in the order of file numbers or in a time series, the user must find the tenth target image from many recorded images using a scroll operation or the like so as to view or select the tenth target image. It would be useful if there is a method of reproducing the tenth target image (more important image for the user) with higher priority.

Note that there is a conventional display method in which when a slide show of a plurality of input images as reproduction objects is performed, one of the plurality of input images is set as a reference image (key image), and similarity between the reference image and a non-reference image is calculated. Then, a non-reference image having higher similarity with the reference image is displayed earlier. This display method, however, cannot suppress the above-mentioned redundancy in the reproduction or cannot contribute to reproduction with higher priority of an image with higher importance.

### SUMMARY OF THE INVENTION

An image reproducing apparatus according to the present invention includes a reproduction control unit which selects n out of given m input images as n output images by evaluating similarity among different input images of the m input images, and outputs the n output images onto a reproduction medium (m is an integer of two or larger, n is an integer of one or larger, and m>n holds).

An image reproducing apparatus according to another aspect of the present invention includes an image classification unit which classifies given m input images into a plurality of categories by evaluating similarity among different input images of the m input images (m is an integer of two or larger), a priority order setting unit which performs a priority order setting process of setting priority orders of a plurality of input images when the plurality of input images belong to the same category, and an image output unit which outputs the m input images onto the reproduction medium in accordance with the priority orders set by performing the priority order setting process for each of the categories.

Meanings and effects of the present invention will be further apparent from the following description of the embodiments. However, the following embodiments are merely examples of the present invention, and meanings of the present invention and individual elements are not limited to those described in the following embodiments.

### BRIEF DESCRIPTION OF THE DRAWINGS

FIG. 1 is a block diagram illustrating a general configuration of an imaging apparatus according to a first embodiment of the present invention.

FIG. 2 is a diagram illustrating a structure of an image file to be recorded in a recording medium illustrated in FIG. 1.

FIG. 3 is a diagram for describing contents of additional data to be stored in a header region of the image file.

FIG. 4 is a diagram illustrating a manner in which five spatial domain filters are used to act on an input image.

FIG. 5 is a diagram illustrating five histograms that are related to derivation of a characteristic vector of the input image.

FIG. 6 is a diagram illustrating a display screen provided to a display unit illustrated in FIG. 1.

FIG. 7 is a diagram illustrating a manner in which the display area of the display screen of the display unit illustrated in FIG. 1 is divided into a plurality of areas.

FIG. 8 is a block diagram of the inside of the reproduction control unit illustrated in FIG. 1.

FIG. 9 is a diagram illustrating contents of similarity to be evaluated by an image selection unit illustrated in FIG. 8.

FIG. 10 is a diagram illustrating a specific example of similarity evaluation and selection process performed by the image selection unit illustrated in FIG. 8.

FIG. 11 is a diagram illustrating twelve input images as an example of m input images supplied to the image selection unit illustrated in FIG. 8.

FIG. 12 is a diagram illustrating contents of a display when a slide show is performed in the case where a reproduction object selection function according to the present invention is enabled.

FIG. 13 is a diagram illustrating contents of a display when a slide show is performed in the case where a reproduction object selection function according to the present invention is disabled.

FIG. 14 is a diagram illustrating contents of a display when a thumbnail display is performed in the case where a reproduction object selection function according to the present invention is enabled.

FIGS. 15A and 15B are diagrams illustrating contents of a display when a thumbnail display is performed in the case where a reproduction object selection function according to the present invention is disabled.

FIG. 16 is a flowchart of an operation in an image sensing mode of the imaging apparatus according to the first embodiment of the present invention.

FIG. 17 is a flowchart of an operation in a reproduction mode of the imaging apparatus according to the first embodiment of the present invention.

FIG. 18 is a diagram illustrating a manner in which a thumbnail of an image selected by the image selection unit and a thumbnail of an image that is not selected by the same are displayed in an overlaid manner according to a second embodiment of the present invention.

FIG. 19 is a diagram illustrating an example of contents of a display in a thumbnail display mode according to the second embodiment of the present invention.

FIG. 20 is a diagram illustrating another example of contents of a display in the thumbnail display mode according to the second embodiment of the present invention.

FIG. 21 is a diagram illustrating an example of contents of a display according to a third embodiment of the present invention.

FIG. 22 is a diagram illustrating an example of contents of a print in the case where the reproduction object selection function according to the present invention is enabled according to a fourth embodiment of the present invention.

FIG. 23 is a diagram illustrating an example of contents of a print in the case where the reproduction object selection function according to the present invention is disabled according to the fourth embodiment of the present invention.

FIG. 24 is a block diagram of a part related to an operation of a sixth embodiment of the present invention.

FIG. 25 is a diagram illustrating a manner in which a plurality of input images assumed in the sixth embodiment of the present invention are classified into a plurality of categories and are assigned with priority orders.

FIG. 26 is a diagram for defining up, down, left and right directions in the display screen according to the sixth embodiment of the present invention.

FIG. 27 is a diagram illustrating an example of a display screen in a list display mode according to the sixth embodiment of the present invention.

FIG. 28 is a diagram for describing a manner in which a display area of the display screen is divided in the list display mode according to the sixth embodiment of the present invention.

FIG. 29 is a diagram illustrating another example of the display screen in the list display mode according to the sixth embodiment of the present invention.

FIG. 30 is a diagram illustrating still another example of the display screen in the list display mode according to the sixth embodiment of the present invention.

FIG. 31 is a diagram illustrating a still another example of the display screen in the list display mode according to the sixth embodiment of the present invention.

FIG. 32 is a diagram illustrating an example of the display screen in the thumbnail display mode according to the sixth embodiment of the present invention.

FIG. 33 is a diagram illustrating an example of the display screen in a slide show mode according to the sixth embodiment of the present invention.

FIG. 34 is a diagram illustrating a manner in which P_{A} input images belong to one category according to the sixth embodiment of the present invention.

FIG. 35 is a diagram illustrating a manner in which an evaluation region is set in an evaluation target image according to the sixth embodiment of the present invention.

FIG. 36 is a diagram illustrating a manner in which reference information is stored in the header region of the image file according to the sixth embodiment of the present invention.

FIG. 37 is a diagram illustrating a manner in which a plurality of decision image areas are set in any two-dimensional image according to the sixth embodiment of the present invention.

FIG. 38 is a diagram illustrating three input images obtained by using an AF control together with in-focus regions thereof according to the sixth embodiment of the present invention.

FIG. 39 is a partial block diagram of the imaging apparatus including the inside structure of the image sensing unit illustrated in FIG. 1.

FIG. 40 is a diagram illustrating a manner in which an AF decision region is set in a frame image according to the sixth embodiment of the present invention.

FIG. 41 is a diagram illustrating a manner in which an input image is obtained via an AF lock operation according to the sixth embodiment of the present invention.

FIG. 42 is a flowchart of an operation of deciding whether or not a frame composition is changed between the AF lock operation and the shutter operation according to the sixth embodiment of the present invention.

FIG. 43 is a diagram illustrating a summary of methods of setting priority orders according to the sixth embodiment of the present invention.

### DETAILED DESCRIPTION OF THE PREFERRED EMBODIMENTS

Hereinafter, embodiments of the present invention will be specifically described with reference to the attached drawings. In the drawings to be referred to, the same part is denoted by the same numeral or symbol so that overlapping description for the same part will be omitted as a rule.

### First Embodiment

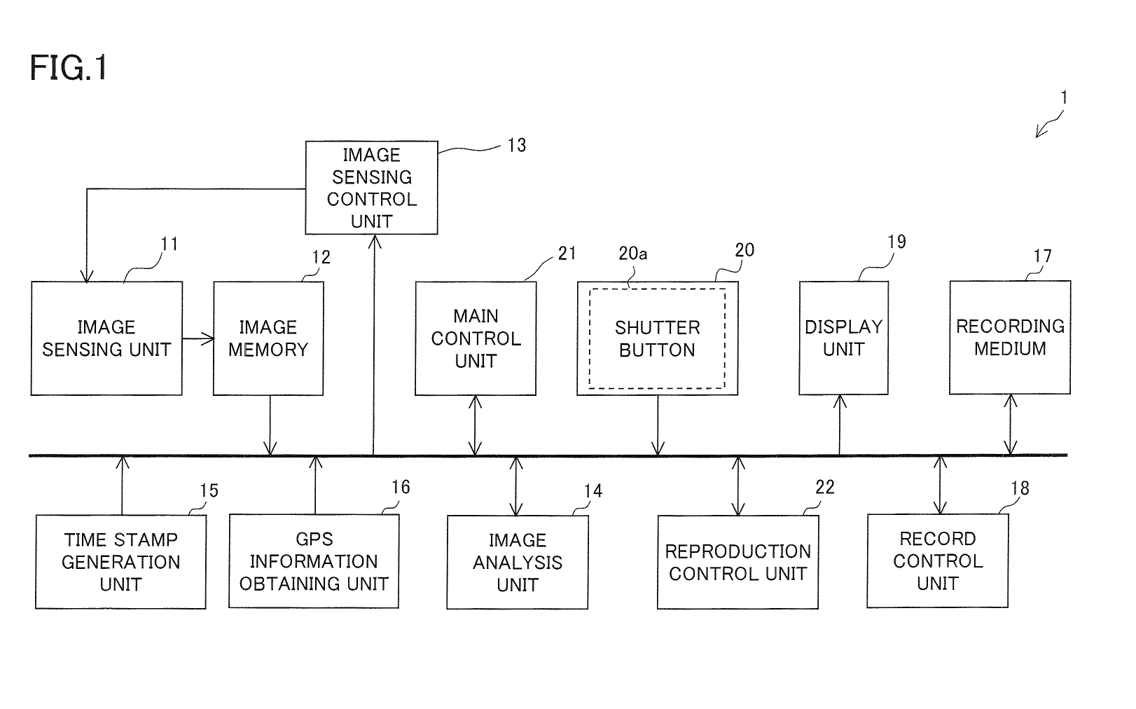

A first embodiment of the present invention will be described. FIG. 1 is a block diagram illustrating a general configuration of an imaging apparatus 1 according to the first embodiment of the present invention. The imaging apparatus 1 includes individual units denoted by numerals 11 to 22. The imaging apparatus 1 is a digital video camera that is capable of taking still images and moving images. However, the imaging apparatus 1 may be a digital still camera that is capable of taking only still images. Note that a display unit 19 may be provided to a display apparatus or the like that is separated from the imaging apparatus 1.

The image sensing unit 11 performs image sensing of a subject with an image sensor so as to obtain image data of an image of the subject. Specifically, the image sensing unit 11 includes an optical system, an aperture stop, and an image sensor constituted of a charge coupled device (CCD), a complementary metal oxide semiconductor (CMOS) image sensor or the like, which are not shown. This image sensor performs photoelectric conversion of an optical image expressing a subject that enters through the optical system and the aperture stop so as to output an analog electric signal obtained by the photoelectric conversion. An analog front end (AFE) that is not shown amplifies an analog signal output from the image sensor and converts the same into a digital signal. The obtained digital signal is recorded as image data of the subject image in an image memory 12 constituted of a synchronous dynamic random access memory (SDRAM) or the like.

One image expressed by image data of one frame period recorded in the image memory 12 is referred to as a frame image in the following description. Note that the image data may be simply referred to as an image in the present specification. In addition, image data of a certain pixel may be referred to as a pixel signal. For example, a pixel signal is constituted of a luminance signal indicating luminance of the pixel and a color difference signal indicating color of the pixel.

The image data of the frame image is sent as image data of an input image to a necessary part in the imaging apparatus 1 (e.g., an image analysis unit 14). In this case, it is possible to perform necessary image processing (noise reduction process, edge enhancement process, or the like) on the image data of the frame image, so as to send the image data after the image processing as the image data of the input image to the image analysis unit 14 or the like

The image sensing control unit 13 controls an angle of view (focal length), a focal position, and a quantity of light entering the image sensor of the image sensing unit 11 based on a user's instruction and/or the image data of the input image.

The image analysis unit 14 performs various types of image analysis based on the image data of the input image. The image analysis performed by the image analysis unit 14 may include a face detection process, a face recognition process and a characteristic vector derivation process.

The image analysis unit 14 detects a face and a person in the input image by a face detection process. In the face detection process, a face region that is a region including a person's face part is detected and extracted from the image area of the input image based on the image data of the input image. The image analysis unit 14 can perform the face detection process by any method including a known method. Hereinafter, an image in the face region extracted by the face detection process is also referred to as an extracted face image. About an image, a term “area” is synonymous with a term “region”.

The image analysis unit 14 can also extract a person region that is a region including a whole body of a person from the image area of the input image by utilizing a result of the face detection process. For instance, based on a position and a size of the face region extracted by the face detection process, an image area in which image data of the person corresponding to the face region exists is estimated, and the estimated image area is extracted as the person region. It is possible to utilize a known contour extraction process or edge extraction process for extracting the person region.

In the face recognition process, it is recognized which person among one or more enrolled persons set in advance is the person having the face extracted from the input image by the face detection process. As a method of the face recognition process, various methods are known. The image analysis unit 14 can perform the face recognition process by any method including known methods.

For instance, the face recognition process can be performed based on the image data of the extracted face image and a face image database for matching. The face image database stores image data of different face images of a plurality of enrolled persons. The face image database can be disposed in the image analysis unit 14 in advance. The enrolled person's face image stored in the face image database is referred to as an enrolled face image. The face recognition process can be realized by performing similarity evaluation between the extracted face image and the enrolled face image for each enrolled face image based on the image data of the extracted face image and the image data of the enrolled face image.

The characteristic vector derivation process means a process of deriving a characteristic vector expressing a characteristic of the entire view of the input image or a background image within the input image. A specific method of deriving the characteristic vector will be described later.

A time stamp generation unit 15 generates time stamp information indicating image sensing time of the input image by using a timer or the like built in the imaging apparatus 1. A GPS information obtaining unit 16 receives GPS signals transmitted from global positioning system (GPS) satellites so as to recognize a current position of the imaging apparatus 1. A recording medium 17 is a nonvolatile memory constituted of a magnetic disk, a semiconductor memory, or the like. The image data of the input image can be stored in an image file and is recorded in the recording medium 17.

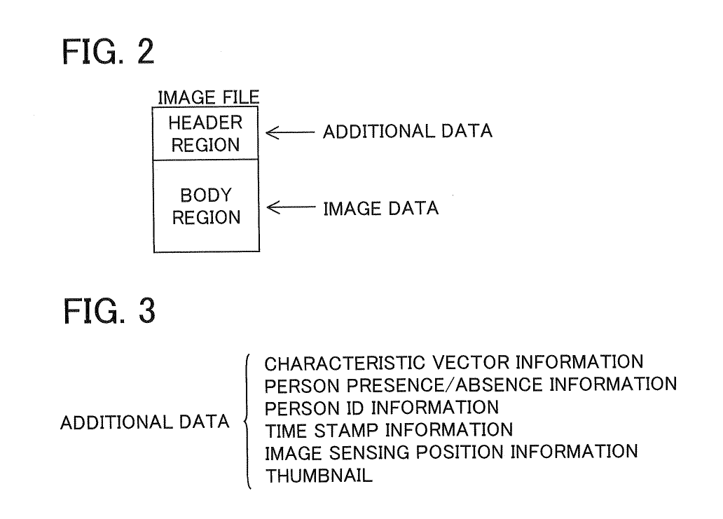

FIG. 2 illustrates a structure of one image file. One image file can be generated for one still image or one moving image. The structure of the image file can conform to any standard. The image file is constituted of a body region storing image data itself of a still image or a moving image or compressed data thereof and a header region storing additional data.

As illustrated in FIG. 3, the additional data of a certain still image can include characteristic vector information indicating a characteristic vector of the still image, person presence/absence information indicating whether or not the still image contains a person, person ID information indicating which enrolled person a person included in the still image is, time stamp information indicating image sensing time of the still image (i.e., time when the still image is generated by the image sensing), and image sensing position information indicating a position where the image sensing of the still image is performed (i.e., position where the still image is generated by the image sensing). In the following description, it is supposed that the additional data of the still image contains all of the above-mentioned information. In addition, the additional data of a certain still image also contain thumbnail image data of the still image. Note that in the present specification, “information” and “data” have the same meaning.

The characteristic vector information, the person presence/absence information and the person ID information to be contained in the additional data of a certain still image are generated based on the characteristic vector derivation process, the face detection process and the face recognition process performed on the still image. The time stamp information and the image sensing position information to be contained in the additional data of a certain still image are generated by the time stamp generation unit 15 and the GPS information obtaining unit 16. The thumbnail of a certain still image is an image obtained by reducing an image size of the still image and is usually generated by thinning out a part of pixels of the still image.

A record control unit 18 performs various types of record control necessary for recording data in the recording medium 17. The display unit 19 is constituted of a liquid crystal display or the like, which displays the input image obtained by image sensing of the image sensing unit 11, the image recorded in the recording medium 17, and the like. An operating unit 20 is a unit for a user to perform various types of operations to the imaging apparatus 1. The operating unit 20 includes a shutter button 20a for issuing instruction of image sensing of a still image, and a record button (not shown) for issuing an instruction to start or stop image sensing of a moving image. A main control unit 21 controls operations of the individual units in the imaging apparatus 1 integrally in accordance with contents of operations performed to the operating unit 20. A reproduction control unit 22 performs reproduction control that is necessary when the image recorded in the recording medium 17 is reproduced on the display unit 19 or the like.

[Derivation Method of Characteristic Vector]

A specific derivation method of the characteristic vector will be described. In the following description, for concrete description, it is supposed that an image area except a person region in the entire image area of a certain noted input image is regarded as a background region, and that a characteristic vector indicating a characteristic of an image in the background region is derived as the characteristic vector of the noted input image.

An image area to be a target of derivation of the characteristic vector is referred to as a characteristic evaluation region. If a person region is extracted from the noted input image, the above-mentioned background region is the characteristic evaluation region. If the noted input image does not include a person region, the entire image area of the noted input image is set as the characteristic evaluation region, a characteristic vector indicating a characteristic of an image in the entire image area as the characteristic evaluation region is derived as the characteristic vector of the noted input image.

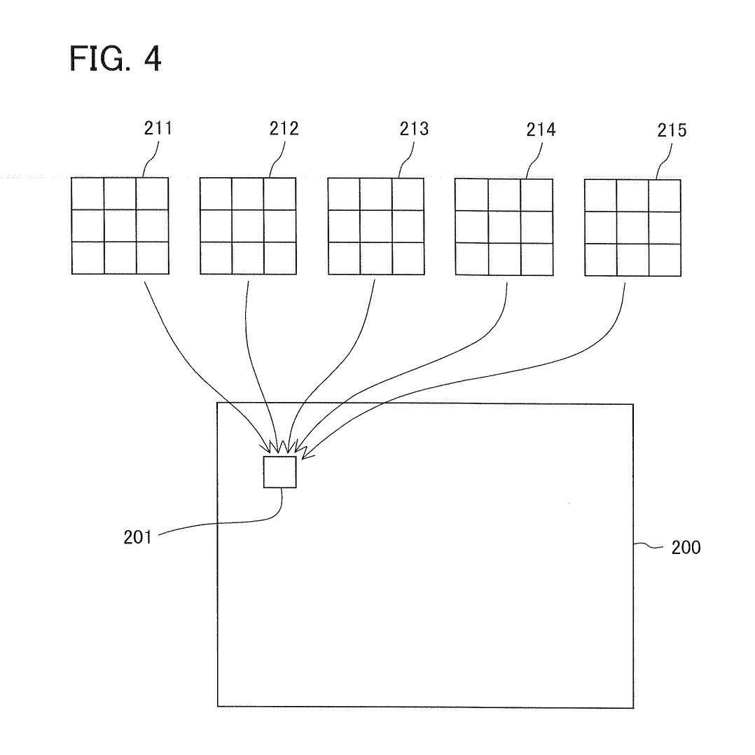

As illustrated in FIG. 4, one input image for which the characteristic vector is to be calculated is denoted by numeral 200. The input image 200 is a two-dimensional image in which a plurality of pixels are arranged in the horizontal and the vertical directions, and numeral 201 in FIG. 4 denotes one noted pixel in the input image 200. The filters 211 to 215 are edge extraction filters for extracting edges of a small image including the noted pixel 201 as a center. The small image is a part of the input image 200. As the edge extraction filter, any spatial domain filter (e.g., differential filter, Prewitt filter, Sobel filter) that is suitable for edge extraction can be used. However, filters 211 to 215 are spatial domain filters different from each other. An edge extraction direction is different among the filters 211 to 215. A filter size of the filters 211 to 215 is 3×3 pixels in FIG. 4, but the filter size thereof may be other than 3×3 pixels.

The filters 211, 212, 213 and 214 respectively extract edges extending in the horizontal direction, the vertical direction, the right oblique direction and the left oblique direction in the input image 200, and output filter output values indicating the extracted edge intensities. The filter 215 extracts an edge extending in a direction that is not classified into any of the horizontal direction, the vertical direction, the right oblique direction and the left oblique direction, and outputs a filter output value indicating an extracted edge intensity. The edge intensity indicates a magnitude of a gradient of a pixel signal (e.g., luminance signal). For instance, if there is an edge extending in the horizontal direction in the input image 200, a relatively large gradient is generated in the pixel signal in the vertical direction that is perpendicular to the horizontal direction. Therefore, by spatial domain filtering is performed by using the filter 211 in the state where the center of the noted pixel 201 is agreed with the center of the filter 211, a gradient of the pixel signal along the vertical direction in the image area of 3×3 pixels with the center of the noted pixel 201 can be obtained as the filter output value. The same is true for the filters 212 to 215.

In the state where the noted pixel 201 is placed at a certain position in the input image 200, individual filter output values are obtained from the filters 211 to 215, so that five filter output values can be obtained. A largest filter output value among the five filter output values is extracted as an adopted filter value. The adopted filter values that are filter output values of the filters 211 to 215 as the largest filter output value are respectively referred to as first to fifth adopted filter values. Therefore, for example, if the largest filter output value is the filter output value of the filter 211, the adopted filter value is the first adopted filter value. If the largest filter output value is the filter output value of the filter 212, the adopted filter value is the second adopted filter value. The same is true for the filters 213 to 215 corresponding to the third to fifth adopted filter values.

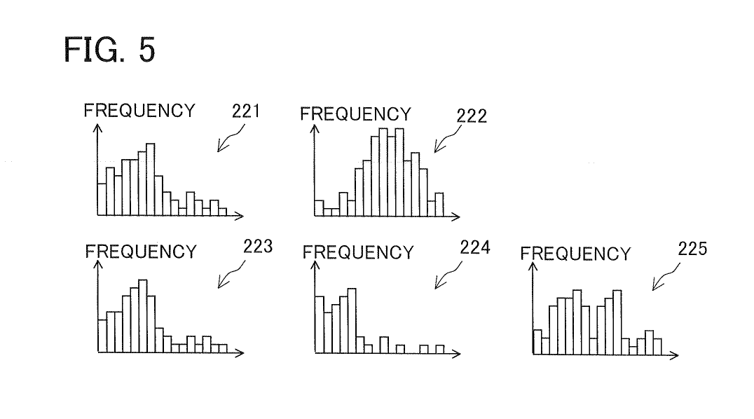

A layout position of the noted pixel 201 is moved in the characteristic evaluation region of the input image 200 in the horizontal or the vertical direction one by one pixel, and in every movement the filter output values of the filters 211 to 215 are obtained so as to decide the adopted filter value. After deciding the adopted filter value for every position in the characteristic evaluation region of the input image 200, the histograms 221, 222, 223, 224 and 225 of the first, second, third, fourth and fifth adopted filter values are generated individually as illustrated in FIG. 5.

The histogram 221 of the first adopted filter values is a histogram of the first adopted filter values obtained from the input image 200, and the number of classes of the histograms is 16 (the same is true for the histograms 222 to 225). Then, since 16 frequency data are obtained from one histogram, total 80 frequency data are obtained from the histograms 221 to 225. An 80-dimensional vector having elements of the 80 frequency data is determined as a shape vector H_{E}. The shape vector H_{E} is a vector corresponding to a shape of an object existing in the input image 200.

On the other hand, the image analysis unit 14 generates color histograms indicating a manner of color in the characteristic evaluation region of the input image 200. For instance, if the pixel signal of each pixel forming the input image 200 is constituted of an R signal indicating intensity of red color, a G signal indicating intensity of green color and a B signal indicating intensity of blue color, the image analysis unit 14 generates a histogram HST_{R} of R signal values in the characteristic evaluation region of the input image 200, a histogram HST_{G} of G signal values in the characteristic evaluation region of the input image 200, and a histogram HST_{B} of B signal values in the characteristic evaluation region of the input image 200 as color histograms of the input image 200. The number of the classes of the color histograms may be any number. If the number of the classes of the color histograms is 16, 48 frequency data are obtained from the color histograms HST_{R}, HST_{G} and HST_{B} of the input image 200. A vector having elements of frequency data obtained from the color histograms (e.g., a 48-dimensional vector) is determined as the color vector H_{C}.

When the characteristic vector of the input image 200 is denoted by H, the characteristic vector H is expressed by the equation “H=k_{C}×H_{C}+k_{E}×H_{E}”, where k_{C} and k_{E} are predetermined coefficients (k_{C}≠0, and k_{E}≠0). The characteristic vector H of the input image 200 is an image characteristic quantity corresponding to a shape and color of an object in the input image 200.

Note that five edge extraction filters are used for derivation of a characteristic vector (characteristic quantity) of an image in the Moving Picture Experts Group (MPEG)7, and the five edge extraction filters in the MPEG7 may be used as the filters 211 to 215. Further, the method specified in the MPEG7 may be applied to the input image 200 so that the characteristic vector H (image characteristic quantity) of the input image 200 is derived.

[Various Modes in Reproduction]

When a predetermined operation is performed to the operating unit 20 illustrated in FIG. 1, the operation mode of the imaging apparatus 1 becomes a reproduction mode in which reproduction of the image recorded in the recording medium 17 is performed. The reproduction mode is classified into a plurality of modes. The plurality of modes include a slide show mode and a thumbnail display mode. When an image is reproduced in the modes, the reproduction control unit 22 can realize a characteristic function. Hereinafter, if a description of the reproduction mode including a slide show mode and a thumbnail display mode simply refers to an input image, it means an input image as the still image recorded in the recording medium 17 (the same is true for other embodiments that will be described later).

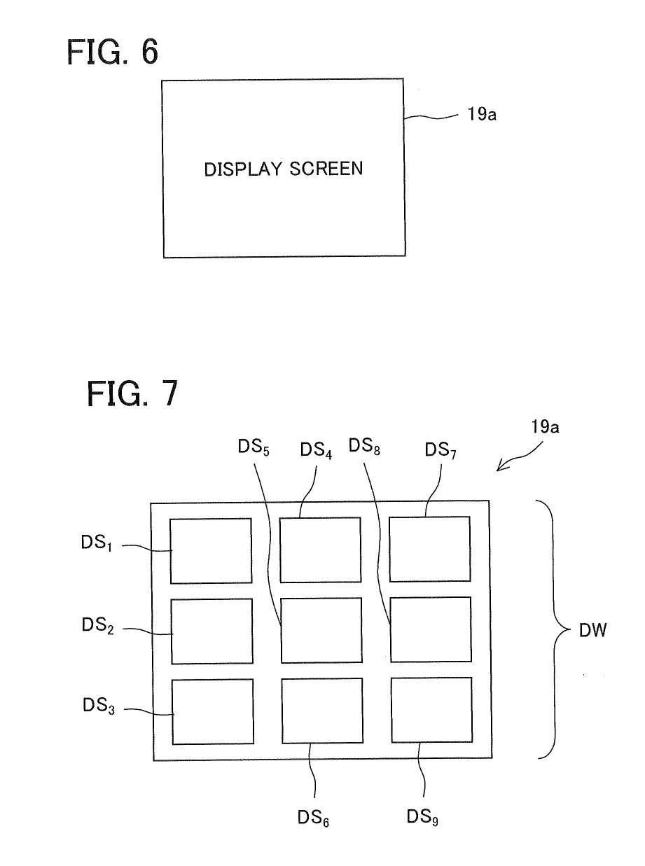

In the reproduction mode, the image data and the additional data of the input image read out from the recording medium 17 are supplied to the reproduction control unit 22, and the reproduction control unit 22 performs necessary reproduction control based on the supplied data. The display screen provided to the display unit 19 is denoted by numeral 19a as illustrated in FIG. 6. The display screen 19a has a display area having a rectangular shape of a predetermined size, and the entire display area of the display screen 19a is denoted by symbol DW as illustrated in FIG. 7. The language “display” in the following description means a display on the display screen 19a unless otherwise mentioned.

In the slide show mode, a plurality of input images are displayed one by one in turn on the display screen 19a. Typically, for example, a plurality of input images are sequentially displayed one by one at a constant interval using the entire display area DW of the display screen 19a.

In the thumbnail display mode, a plurality of thumbnail of a plurality of input images are display on the display screen 19a simultaneously. For instance, the entire display area DW is divided equally by three in the horizontal and the vertical directions each, so that the entire display area DW is divided into nine display areas for use. The nine divided display areas obtained by this division are denoted by symbols DS₁ to DS₉ as illustrated in FIG. 7. Then, in the thumbnail display mode, one thumbnail of the input image is displayed in each of the divided display areas DS₁ to DS₉.

In a usual slide show mode and thumbnail display mode, all the input images read out from the recording medium 17 are objects of reproduction, but the reproduction control unit 22 illustrated in FIG. 1 has a function of automatically recognizing input images having little necessity of reproduction so as to exclude the same from the objects of reproduction. This function is referred to as a reproduction object selection function. It is possible to perform the operations in the slide show mode and the thumbnail display mode in the state where the reproduction object selection function is disabled. In the following description, a reproduction operation when the reproduction object selection function is enabled will be described unless otherwise mentioned.

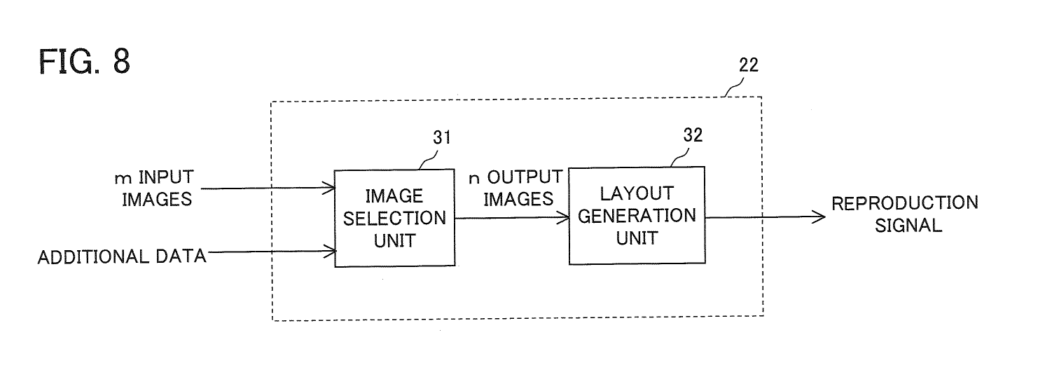

FIG. 8 is a block diagram of the inside of the reproduction control unit 22. The reproduction control unit 22 has an image selection unit 31 and a layout generation unit (signal generation unit) 32. The image selection unit 31 selects n input images from m input images based on m input images and the additional data corresponding to the m input images read out from the recording medium 17. Here, m and n are integers of 2 or larger, and m is larger than n. The input image selected by the image selection unit 31 is also referred to as an output image. The image data of each output image is supplied to the layout generation unit 32.

The layout generation unit 32 generates a layout of the display screen 19a based on the type of the reproduction mode, i.e., based on whether the reproduction mode specified by the user is the slide show mode or the thumbnail display mode. Then, the layout generation unit 32 outputs to the display unit 19 a reproduction signal for reproducing and displaying each output image in accordance with the generated layout on the display screen 19a. If the specified reproduction mode is the slide show mode, a layout for displaying one output image in the entire display area DW is generated. If the specified reproduction mode is the thumbnail display mode, a layout for displaying each of the thumbnails of nine output images in each of the divided display areas DS₁ to DS₉ is generated.

[Selection Method Based on Similarity Evaluation]

The image selection unit 31 evaluates similarities between any different input images among m input images based on the additional data of m input images when the selection process is performed.

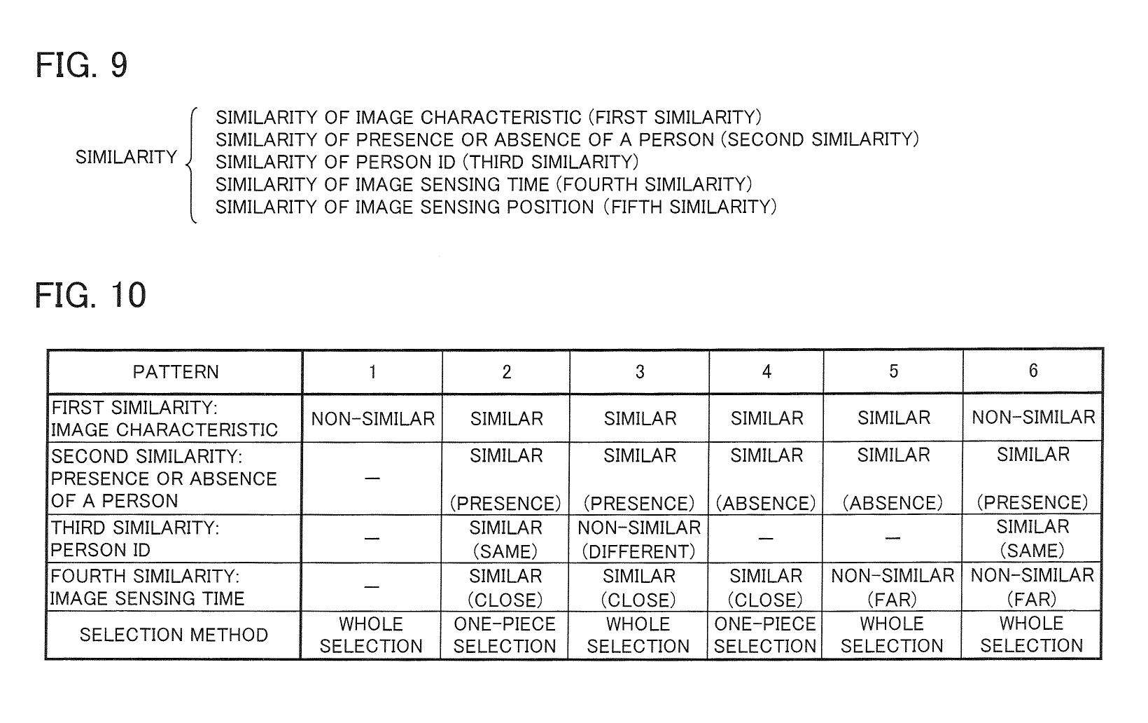

As illustrated in FIG. 9, the similarities to be evaluated here may include a similarity of an image characteristic (hereinafter, referred to as a first similarity), a similarity of presence or absence of a person (hereinafter, referred to as a second similarity), a similarity of a person ID (hereinafter, referred to as a third similarity), a similarity of image sensing time (hereinafter, referred to as a fourth similarity), and a similarity of image sensing position (hereinafter, referred to as a fifth similarity). Noting the first and the second input images included in the m input images, an evaluation method of the similarities will be described.

The similarity of an image characteristic between the first and the second input images is evaluated based on the characteristic vector information of the first and the second input images as follows. A characteristic vector H₁ of the first input image and a characteristic vector H₂ of the second input image are placed in a characteristic space in which the characteristic vectors are to be defined. In this case, start points of the characteristic vectors H₁ and H₂ are placed at an origin in the characteristic space, and a distance (Euclidean distance) between an end point of the characteristic vector H₁ and an end point of the characteristic vector H₂ in the characteristic space is determined. Then, if the determined distance is smaller than a predetermined reference distance, it is decided that the similarity of the image characteristic between the first and the second input images is high. If the determined distance is the reference distance or larger, it is decided that the similarity of the image characteristic between the first and the second input images is low.

The similarity of presence or absence of a person between the first and the second input images is evaluated based on the person presence/absence information of the first and the second input images. In other words, if a person is included in both the first and the second input images, or if a person is not included in both the first and the second input images, it is decided that the similarity of presence or absence of a person between the first and the second input images is high. If a person is included in only one of the first and the second input images, it is decided that the similarity of presence or absence of a person between the first and the second input images is low. In addition, even if a person is included in both the first and the second input images, if the number of included persons is difference between the first and the second input images, it may be decided that the similarity of presence or absence of a person between the first and the second input images is low. In order to enable this decision, it is preferable that the person presence/absence information includes information indicating the number of persons included in the input image.

The similarity of the person ID between the first and the second input images is evaluated based on the person ID information of the first and the second input images. The person ID is information for recognizing the person included in the input image in a manner of distinguishing the same from other persons. Specifically, if the persons included in the first and the second input images are the same enrolled person, it is decided that the similarity of the person ID between the first and the second input images is high. If the persons included in the first and the second input images are not the same enrolled person, it is decided that the similarity of the person ID between the first and the second input images is low.

The similarity of image sensing time between the first and the second input images is evaluated based on time stamp information of the first and the second input images. Specifically, for example, a time difference between image sensing time of the first input image and image sensing time of the second input image is determined from time stamp information thereof. If the time difference is smaller than a predetermined reference time difference, it is decided that the similarity of image sensing time between the first and the second input images is high. If the time difference is the reference time difference or larger, it is decided that the similarity of image sensing time between the first and the second input images is low.

The similarity of image sensing position between the first and the second input images is evaluated based on the image sensing position information of the first and the second input images. Specifically, for example, a position difference between an image sensing position of the first input image and an image sensing position of the second input image is determined from the image sensing position information thereof If the position difference is smaller than a predetermined reference position difference, it is decided that the similarity of image sensing position between the first and the second input images is high. If the position difference is the reference position difference or larger, it is decided that the similarity of image sensing position between the first and the second input images is low. The position difference can be expressed by a distance between the positions to be compared, for example.

The image selection unit 31 adopts one or more similarities as a selection index similarity among the first to the fifth similarities and selects n input images from m input images based on a level of the selection index similarity. Therefore, the number of selection index similarities is any one of 1, 2, 3, 4 and 5. However, it is desirable that the selection index similarities include at least the first similarity. For instance, if only the first and the second similarities are used as the selection index similarities, n input images are selected as n output images from m input images based on only the first and the second similarities without considering levels of the third to the fifth similarities.

If it is decided that all the selection index similarities are high between the first and the second input images, output images are selected so that one of the first and the second input images is excluded from the n output images. Such a selection (or a selection method) is referred to as a one-piece selection. In addition, to decide that all the selection index similarities are high among the noted plurality of input images is referred to as similarity decision for convenience sake.

On the other hand, if it is decided that any one or more of the selection index similarities are low between the first and the second input images, the output images are selected so that both the first and the second input images are included in the n output images. Such a selection (or a selection method) is referred to as a whole selection. In addition, to decide that one or more selection index similarities are low among the noted plurality of input images is referred to as non-similarity decision for convenience sake.

However, even if the non-similarity decision is made between the first and the second input images, if the similarity decision is made between the first and the third input images, one of the first and the third input images is excluded from the n output images. Therefore, at the end, the first input image may be excluded from the n output images. In addition, if the similarity decision is made between the first and the second input images, the second input image is excluded from the n output images and the first input image is temporarily included in the n output images, for example. However, in this case too, if the similarity decision is made between the first and the third input images, the first input image may be excluded from the n output images at the end.

With reference to FIG. 10, first to sixth patterns as specific examples of the similarity evaluation and the selection process performed by the image selection unit 31 will be described. Note that high similarity is referred to as “similar”, and low similarity is referred to as “non-similar” in FIG. 10.

In the first pattern, only the first similarity is adopted as the selection index similarity among the first to the fifth similarities. In this case, if it is decided that the first similarity between the first and the second input images is high, the one-piece selection is made with respect to the first and the second input images. If it is decided that the first similarity is low between the first and the second input images, the whole selection is made with respect to the first and the second input images. FIG. 10 illustrates an example of the case where the whole selection is made. Even if not only the first similarity but also the second similarity is included in the selection index similarities, if the first similarity is low, the whole selection is made regardless of a level of the second similarity.

In the second, the third and the sixth patterns, only the first to the fourth similarities among the first to the fifth similarities are adopted as the selection index similarities.

Then, in the second pattern, it is decided that all the first similarity to the fourth similarity are high between the first and the second input images. In other words, for example, in the second pattern, the similarity of the image characteristic is high between the first and the second input images, and the same enrolled person is included in the first and the second input images, and the image sensing time difference between the first and the second input images is smaller than a predetermined reference time difference. Therefore, in the second pattern, the one-piece selection is made with respect to the first and the second input images.

On the other hand, in the third pattern, it is decided that the first, the second and the fourth similarities are high between the first and the second input images, but it is decided that the third similarity is low. In other words, for example, in the third pattern, the similarity of the image characteristic is high between the first and the second input images, and the image sensing time difference between the first and the second input images is smaller than a predetermined reference time difference, and a person is included in both the first and the second input images, but the person included in the first input image is not the same as the person included in the second input image. Therefore, in the third pattern, the whole selection is made with respect to the first and the second input images.

In addition, in the sixth pattern, it is decided that the second and the third similarities are high between the first and the second input images, but it is decided that the first and the fourth similarities are low. In other words, for example, in the sixth pattern, the same enrolled person is included in the first and the second input images, but the similarity of the image characteristic is low between the first and the second input images, and the image sensing time difference between the first and the second input images is larger than the predetermined reference time difference. Therefore, in the sixth pattern, the whole selection is made with respect to the first and the second input images.

In the fourth and the fifth pattern, only the first, the second and the fourth similarities among the first to the fifth similarities are adopted as the selection index similarities.

Then in the fourth pattern, it is decided that all of the first, the second and the fourth similarity are high between the first and the second input images. In other words, for example, in the fourth pattern, between the first and the second input images, the similarity of the image characteristic is high, and a person is included in both the first and the second input images, and the image sensing time difference between the first and the second input images is smaller than the predetermined reference time difference. Therefore, in the fourth pattern, the one-piece selection is made with respect to the first and the second input images.

On the other hand, in the fifth pattern, it is decided that the first and the second similarities are high between the first and the second input images, but it is decided that the fourth similarity is low. In other words, for example, in the fifth pattern, between the first and the second input images, the similarity of the image characteristic is high, and a person is included in both the first and the second input images, but the image sensing time difference between the first and the second input images is larger than the predetermined reference time difference. Therefore, in the fifth pattern, the whole selection is made with respect to the first and the second input images.

If the first similarity is high between the first and the second input images, since both the images are similar to each other, it is possible to make the one-piece selection with respect to the first and the second input images. In this case, if the fourth similarity between the first and the second input images is also high, it is estimated that the first and the second input images are obtained by continuous image sensing in the same frame composition of a landscape and a person at close time points. Therefore, there is little problem even if one of the first and the second input images is excluded from the n output images so as to omit a display of one of the first and the second input images. In addition, this omission suppresses a redundant display. However, even if the first similarity between the first and the second input images is high, if the first and the second input images are obtained by image sensing at different time points that are substantially apart from each other, it is estimated that the first and the second input images have the same degree of importance. For instance, there may be the case where a landscape of the mountain is taken as the first input image when climbing a mountain, and the same landscape is taken at the same place as the second input image when descending the mountain. It is considered that both the input images have high importance although they are similar images. Considering this, it is desirable to include the fourth similarity in the selection index similarities.

[About One-Piece Selection]

It may be decided which one of the first and the second input images should be selected as the output image based on various auxiliary indexes when the one-piece selection is made between the first and the second input images. Simply, for example, when the one-piece selection is made between the first and the second input images, one with later image sensing time may be selected as the output image based on the time stamp information, or the other with earlier image sensing time may be selected as the output image based on the time stamp information.

In addition, for example, it is possible to perform the one-piece selection based on blur amounts of the first and the second input images. In other words, when the one-piece selection is made between the first and the second input images, blur amounts of the first and the second input images are detected, and the input image with smaller blur amount may be selected as the output image. The image selection unit 31 or the image analysis unit 14 can detect blur amounts of the input images. The blur amount of the input image means an amount indicating the degree of a blur of the input image, and the blur of the input image is generated by a shake of a body of the imaging apparatus 1 during the exposure period of the input image, or by movement of the subject in the real space during the exposure period of the input image.

For instance, the blur amount can be detected by utilizing a characteristic that high frequency components in the image are attenuated if the image includes blur. In other words, predetermined high frequency components are extracted from the input image, and the blur amount can be detected based on an amount of the extracted high frequency components. The amount of the high frequency components can be referred to as intensity of high frequency components.

More specifically, for example, a spatial domain filtering process using a high pass filter (HPF) is performed on each pixel in the noted input image, so that predetermined high frequency components in the luminance signal of the noted input image are extracted. The HPF is a Laplacian filter, for example. After that, amplitudes of the high frequency components extracted by the HPF (i.e., absolute values of output values of the HPF) are integrated, and the integrated value is determined as a blur amount score. The blur amount score of the noted input image increases along with a decrease of the blur amount of the noted input image. Therefore, each of the first and the second input images for which the one-piece selection is to be made is regarded as the noted input image, so that blur amount score of each of the first and the second input images is determined. Then, the input image with a larger blur amount score can be selected as the output image among the first and the second input images. Although the case where the blur amount is detected by extraction of high frequency components is exemplified, it is possible to detect the blur amount by using any other method including a known blur amount detection method.

In addition, if the first and the second input images include a person, a blink detection process for detecting an opened or closed state of the person's eyes, or an expression detection process for detecting an expression of the person's face in the input image may be used for making the one-piece selection. The blink detection process and the expression detection process may be performed by the image selection unit 31 or the image analysis unit 14.

In the blink detection process, an eye region in which eyes exist is extracted from the face region of the noted input image based on the image data of the noted input image, the opened or closed state of eyes in the eye region is detected. For instance, a template matching process is performed using an image indicating an average pupil as a template so as to detect presence or absence of pupils in the eye region. According to the detection result of presence or absence, it can be detected whether or not the eyes are opened. Then, for example, when the one-piece selection is made between the first and the second input images, if it is decided that the person's eyes in the first input image are opened and if it is decided that the person's eyes in the second input image are closed, the first input image should be selected as the output image.

The expression detection process is, for example, a smiling face detection process for detecting whether or not a person's face in the noted input image is smiling based on the image data of the noted input image. As a method of the smiling face detection process, any method including known methods can be utilized. Then, for example, when the one-piece selection is made between the first and the second input images, if it is decided that the person's face in the first input image is smiling and if it is decided that the person's face in the second input image is not smiling, the first input image should be selected as the output image.

[Specific Display Method]

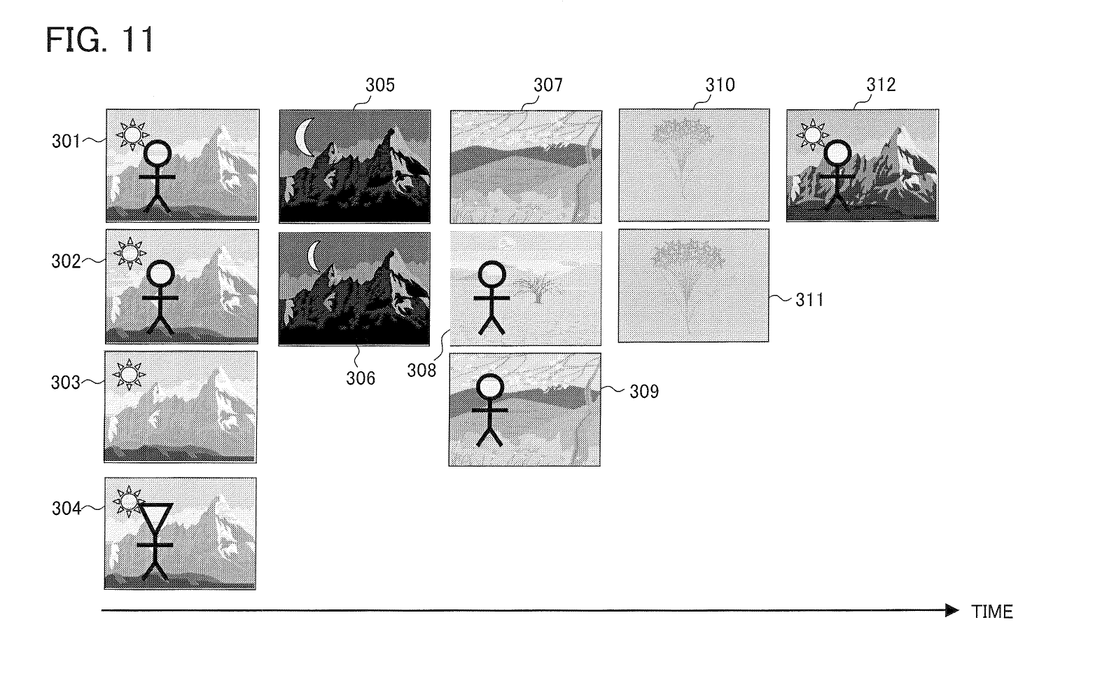

Supposing that the twelve input images 301 to 312 illustrated in FIG. 11 are recorded in the recording medium 17 and that the image data of the input images 301 to 312 and the additional data of the input images 301 to 312 are supplied to the image selection unit 31, displays in the slide show mode and the thumbnail display mode will be described.

It is supposed that the image sensing time of the input image 301 is the earliest among the input images 301 to 312 and that image sensing of the input images 301, 302, 303, 304, 305, 306, 307, 308, 309, 310, 311 and 312 is performed in this order. In addition, it is supposed that different first and second enrolled persons are included in a plurality of enrolled persons that can be distinguished by the face recognition process and that the first enrolled person is included in the input images 301, 302, 308, 309 and 312 while the second enrolled person is included in the input image 304.

The first to the fourth similarities are adopted as the selection index similarities, and the selection process of the output image is performed with respect to the input images 301 to 312 as follows.

The input images 301 to 304 are obtained by image sensing of the same landscape at time points that are close to each other. The input images 301 and 302 include the first enrolled person, the input image 304 includes the second enrolled person, and the input image 303 does not include a person. As a result, the one-piece selection is made between the input images 301 and 302 so that one of the input images 301 and 302 is excluded from the n output images.

The input images 305 and 306 are obtained by image sensing of the same landscape at time points that are close to each other, and the input images 305 and 306 do not include a person. As a result, the one-piece selection is made between the input images 305 and 306 so that one of the input images 305 and 306 is excluded from the n output images.

The input images 307 and 309 are obtained by image sensing of the same landscape at time points that are close to each other. However, the input image 307 does not include a person while the input image 309 includes a first enrolled person. Therefore, the whole selection is made with respect to the input images 307 and 309. The input images 308 and 309 are obtained by image sensing at time points that are close to each other and include a first enrolled person, but the landscape (background) is substantially different between both images. Therefore, the first similarity between both images is low. Thus, the whole selection is made with respect to the input images 308 and 309.

The input images 310 and 311 are obtained by image sensing of the same flower in substantially the same frame composition at time points that are close to each other. As a result, the one-piece selection is made between the input images 310 and 311 so that one of the input images 310 and 311 is excluded from the n output images.

The input image 312 is obtained by image sensing in substantially the same frame composition as the input images 301 and 302, and the first enrolled person is included in the input image 312 similarly to the input images 301 and 302. However, since a difference between the image sensing times of the input images 301 and 302 and the image sensing time of the input image 312 is larger than the above-mentioned reference time difference, the input image 312 is included in the n output images.

As a result of the above-mentioned process, it is supposed that the input images 301, 303, 304, 305, 307, 308, 309, 310 and 312 are selected as the n output images from the input images 301 to 312, and that the input images 302, 306 and 311 are excluded from the n output images (in this case, n=9).

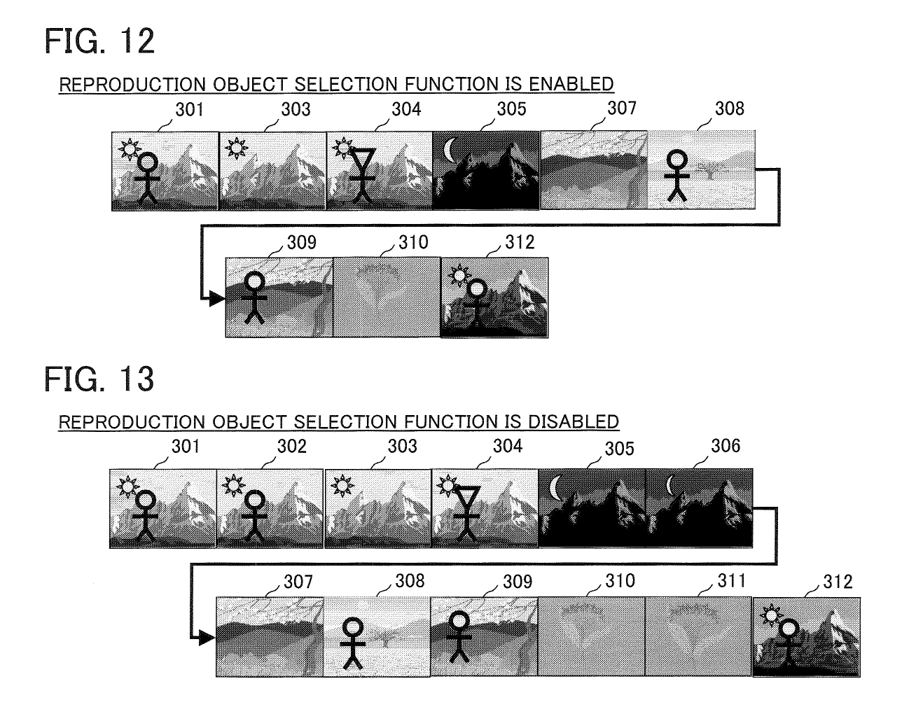

Then, in the state where the reproduction object selection function is enabled, if the operation in the slide show mode is performed with respect to the input images 301 to 312, as illustrated in FIG. 12, the input images 301, 303, 304, 305, 307, 308, 309, 310 and 312 are displayed sequentially at a constant time interval, while the input images 302, 306 and 311 are not displayed. Note that if the operation in the slide show mode is performed with respect to the input images 301 to 312 in the state where the reproduction object selection function is disabled, as illustrated in FIG. 13, total twelve input images 301 to 312 are displayed sequentially at a constant time interval. In the state where the reproduction object selection function is disabled, similar images (e.g., the image 301 and the image 302) are displayed in an overlapping manner in the series of slide show, so that contents of the display may become redundant.

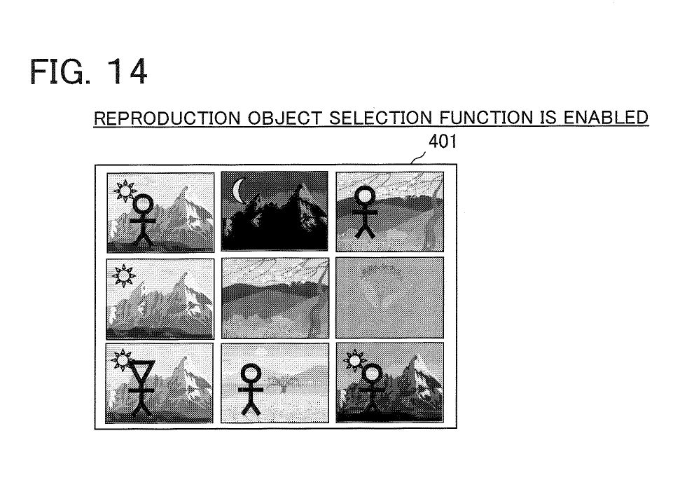

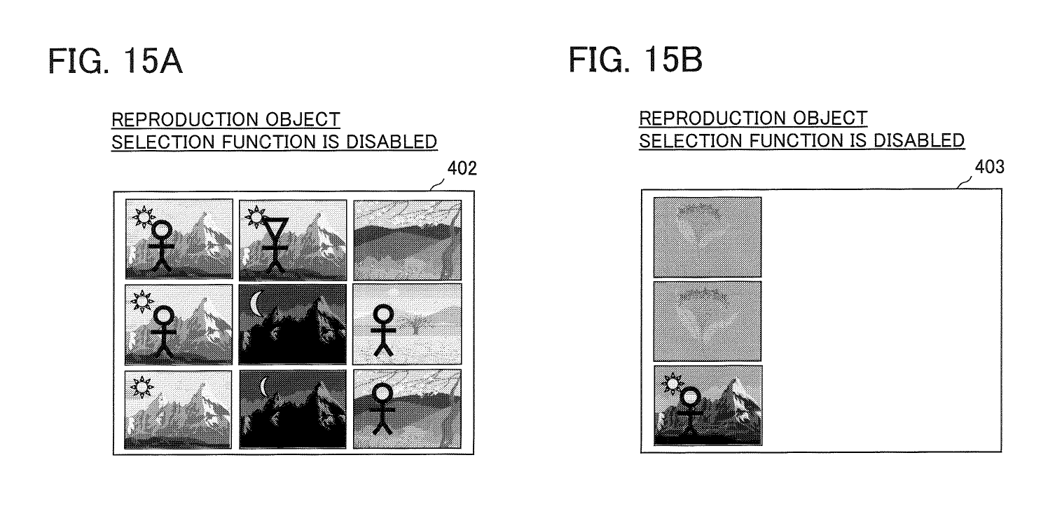

In addition, if the operation in the thumbnail display mode is performed with respect to the input images 301 to 312 in the state where the reproduction object selection function is enabled, as illustrated in FIG. 14, one display image 401 in which thumbnails of the input images 301, 303, 304, 305, 307, 308, 309, 310 and 312 are arranged in the divided display areas DS₁ to DS₉ (see FIG. 7) is displayed, while thumbnails of the input images 302, 306 and 311 are not displayed. Note that if the operation in the thumbnail display mode is performed with respect to the input images 301 to 312 in the state where the reproduction object selection function is disabled, as illustrated in FIG. 15A, one display image 402 in which thumbnails of the input images 301 to 309 are arranged in the divided display areas DS₁ to DS₉ is displayed. If a predetermined operation is performed while this display image is displayed, as illustrated in FIG. 15B, one display image 403 in which thumbnails of the input image 310 to 312 are arranged in the divided display area DS₁ to DS₃ is displayed. In the state where the reproduction object selection function is disabled, thumbnails of similar images (e.g., the image 301 and the image 302) are displayed in an overlapping manner, so that contents of the display may become redundant.

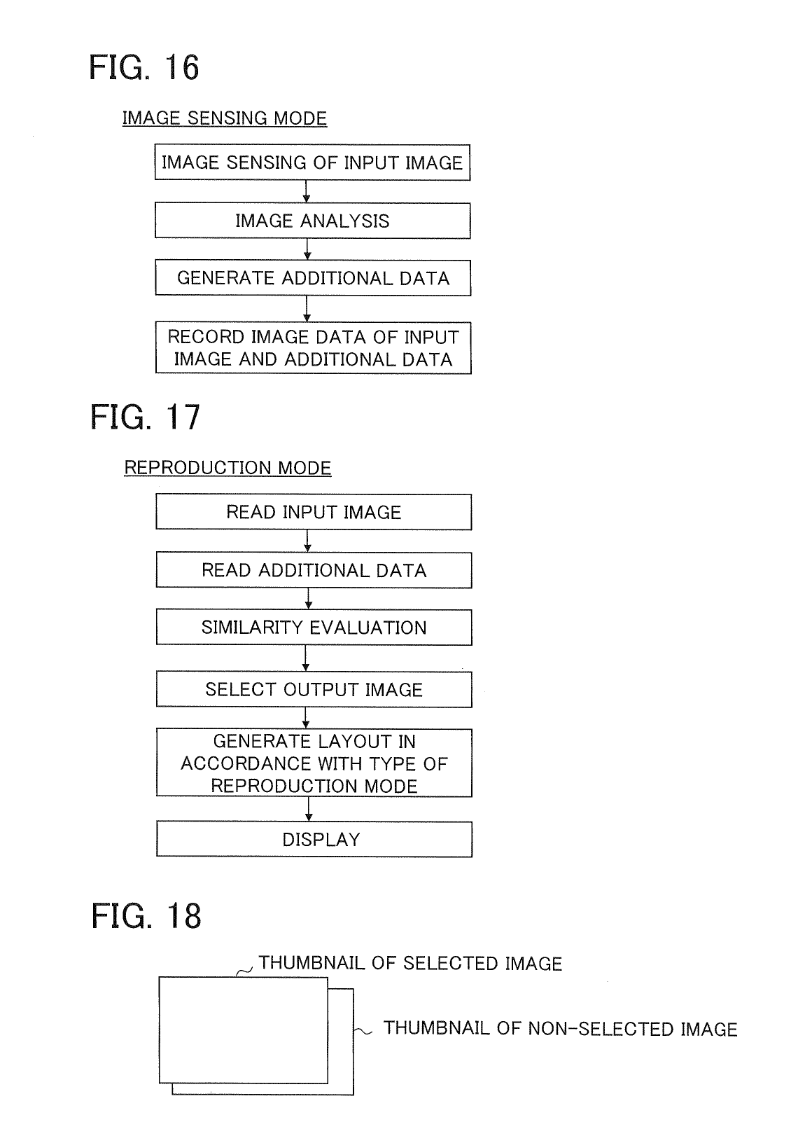

FIG. 16 illustrates an operation flowchart of the imaging apparatus 1 in the image sensing mode. In the image sensing mode, the image data of the input image is obtained by image sensing. Based on the obtained image data, the image analysis is performed. Then, the additional data is generated from a result of the image analysis and the like, and an image file storing the additional data and the image data of the input image is recorded in the recording medium 17. Such a process from the image sensing to the recording is performed every time when the shutter button 20a is pressed down so as to issue the instruction for image sensing of a still image.

FIG. 17 illustrates an operation flowchart of the imaging apparatus 1 in the reproduction mode. In the reproduction mode, image data of m input images and additional data of the m input images are read out from the recording medium 17, so that the similarity evaluation is performed based on the additional data. The n output images are selected from the m input images based on a result of the similarity evaluation. On the other hand, a layout of the display screen 19a is generated based on the type of the reproduction mode, and the output images are displayed in accordance with the generated layout.

According to the first embodiment, an image that is similar to the image that is actually displayed and an image with low importance are not displayed, so that a redundant display is suppressed and time necessary for reproduction is reduced.

Note that in the above description, the output images are displayed sequentially one by one on the display screen 19a in the slide show mode, but k output images may be displayed at once on the display screen 19a in the sequential display (here, k is an integer of two or larger, and n≧k holds). In summary, the output images are displayed by q images at one time sequentially on the display screen 19a (q is an integer of one or more, and n>q holds). For instance, the following display may be performed. If the input image 301, 303, 304, 305, 307, 308, 309, 310 and 312 are selected as nine output images and k=2 holds, the input images 301 and 303 are displayed in an aligned manner horizontally or vertically on the display screen 19a at the first timing, the input images 304 and 305 are displayed in an aligned manner horizontally or vertically on the display screen 19a at the second timing, the input images 307 and 308 are displayed in an aligned manner horizontally or vertically on the display screen 19a at the third timing, the input images 309 and 310 are displayed in an aligned manner horizontally or vertically on the display screen 19a at the fourth timing, and only the input image 311 is displayed on the display screen 19a at the fifth timing. Here, the (i+1)th timing is a timing after the i-th timing (i is an integer).

### Second Embodiment

A second embodiment of the present invention will be described. The second embodiment and other embodiments described later are variations of the first embodiment. The description described in the first embodiment is applied also to the second embodiment and other embodiments described later, unless otherwise mentioned and as long as no contradiction arises. The second embodiment will describe a variation display method of in the thumbnail display mode.

Among the m input images supplied to the image selection unit 31 illustrated in FIG. 8, an input image that is not included in the n output images is referred to as a non-selected image. Corresponding to the name of “non-selected image”, an input image that is included in the n output images is also referred to as a selected image.

In the second embodiment, in the thumbnail display mode, a part of thumbnail of the non-selected image is displayed together with the thumbnail of the selected image. In this case, as illustrated in FIG. 18, on the display screen 19a, a position of the thumbnail of the non-selected image is shifted from a position of the thumbnail of the selected image corresponding to the non-selected image so that thumbnails of them are overlapped with each other, and that the thumbnail of the non-selected image is arranged under the thumbnail of the selected image corresponding to the non-selected image. Therefore, within the thumbnail of the non-selected image, an image portion arranged under the thumbnail of the selected image is not displayed.

If it is decided that all the selection index similarities are high with respect to the first and the second input images, so that the one-piece selection is made between the first and the second input images, one of the first and the second input images is set as the selected image, and the other is set as the non-selected image corresponding to the selected image.

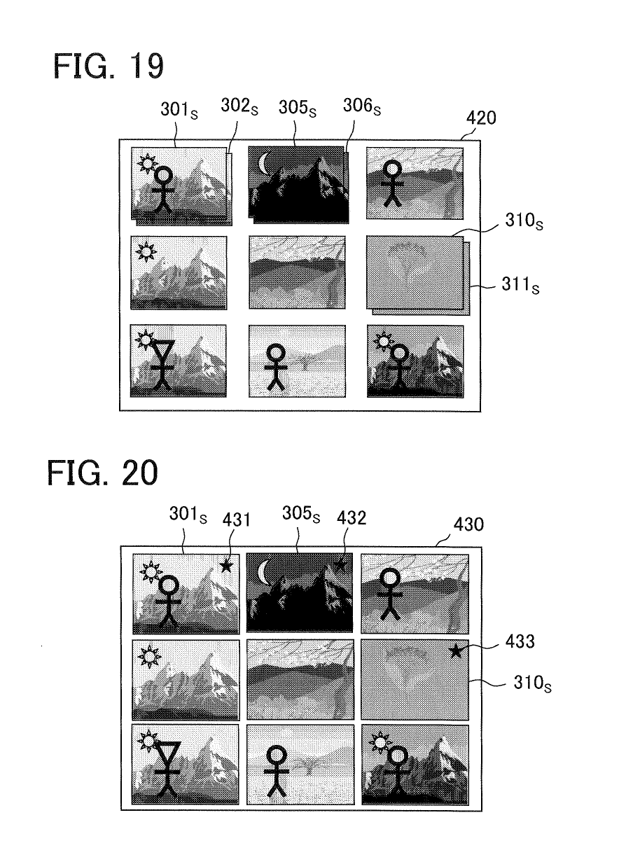

Therefore, as the example described above in the first embodiment (see FIG. 11), the one-piece selection is made between the input images 301 and 302, the one-piece selection is made between the input images 305 and 306, and the one-piece selection is made between the input images 310 and 311, so that the input image 301, 303, 304, 305, 307, 308, 309, 310 and 312 are selected as the n output images from the input images 301 to 312. In this case, the display image 420 as illustrated in FIG. 19 is displayed in the thumbnail display mode.

In the display image 420, the thumbnails of the input images 301, 303, 304, 305, 307, 308, 309, 310 and 312 are arranged in the divided display areas DS₁ to DS₉ (see FIG. 7). Further, a thumbnail 302_{S} of the input image 302 as the non-selected image is disposed under a thumbnail 301_{S} of the input image 301 displayed in the divided display area DS₁, a thumbnail 306_{S} of the input image 306 as the non-selected image is disposed under a thumbnail 305_{S} of the input image 305 displayed in the divided display area DS₄, and a thumbnail 311_{S} of the input image 311 as the non-selected image is disposed under a thumbnail 310_{S} of the input image 310 displayed in the divided display area DS₈. As described above, a part of the thumbnails 302_{S}, 306_{S} and 311_{S} are displayed while the images of the thumbnails 302_{S}, 306_{S} and 311_{S} are not displayed at the part where they are overlapped with the thumbnails 301_{S}, 305_{S} and 310_{S}.

In the state where the display image 420 illustrated in FIG. 19 is displayed, for example, when the user selects the divided display area DS₁ via the operating unit 20, the thumbnail 302_{S} may be displayed instead of the thumbnail 301_{S} in the divided display area DS₁ (the same is true for the divided display areas DS₄ and DS₈). Note that in the example of the display image 420, the number of the non-selected images corresponding to the input image 301 is one. If the number of the non-selected images corresponding to the input image 301 is two or larger, a thumbnail of each of the non-selected images corresponding to the input image 301 is displayed under the thumbnail 301_{S} (the same is true for the input images 305 and 310).

In addition, instead of the display image 420 illustrated in FIG. 19, the display image 430 illustrated in FIG. 20 may be displayed. The display image 430 is obtained by superimposing marks 431 to 433 on the display image 401 illustrated in FIG. 14. The marks 431, 432 and 433 are drawn on the thumbnails 301_{S}, 305_{S} and 310_{S}, respectively, so that each of the marks 431 to 433 can be viewed and recognized. The marks 431, 432 and 433 are indicators for notifying the user that there are non-selected images corresponding to the input images 301, 305 and 310, respectively. Other method than displaying the marks 431, 432 and 433 may be used for realizing the notification. For instance, a display color of frames of the thumbnails 301_{S}, 305_{S} and 310_{S} may be different from those of the other thumbnails so as to realize the notification.

According to the second embodiment too, the same effect as the first embodiment can be obtained. Further, since a part of the thumbnails of the non-selected image may be displayed in association with the selected images in the thumbnail display mode, or since the mark illustrated in FIG. 20 or the like is displayed, the user can recognize that there is a non-selected image at a glance.

### Third Embodiment

A third embodiment of the present invention will be described. In the third embodiment, an operation of a similar axis reproduction mode that is a type of the reproduction mode will be described. When the user specifies any thumbnail displayed in the thumbnail display mode, an input image corresponding to the specified thumbnail is set as a reference image. Then, the display operation of the similar axis reproduction mode is performed with respect to the reference image.

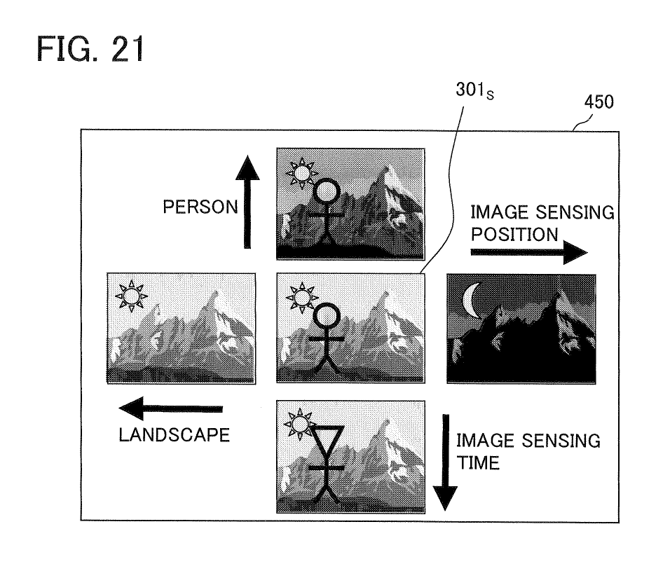

For instance, it is supposed that the user specifies the thumbnail 301_{S} of the input image 301 so that the input image 301 is set as the reference image (see FIG. 19 and the like). In this case, after the thumbnail 301_{S} is specified, the display image 450 as illustrated in FIG. 21 is displayed.

In the display image 450, the thumbnail 301_{S} of the input image 301 as the reference image is displayed in the divided display area DS₅. In the display image 450, thumbnails of the input images in which the third, the first, the fourth and the fifth similarities with the reference image are high are displayed respectively in the divided display areas DS₄, DS₂, DS₆ and DS₈ adjacent to the upper, left, lower and right sides of the divided display area DS₅ (see FIG. 9). The similarity evaluation between the reference image and an input image other than the reference image is already performed in the process of selecting the n output images from the m input images.

The following description is added though it overlaps partially with the example described in the first embodiment (see FIGS. 9 and 11). The following is supposed:

the input images in which the third similarity with the input image 301 is high are the input images 302, 308, 309 and 312;

the input images in which the first similarity with the input image 301 is high are the input images 302, 303, 304 and 312;

the input images in which the fourth similarity with the input image 301 is high are the input images 302, 303 and 304; and

the input images in which the fifth similarity with the input image 301 is high are the input images 302, 303, 304, 305, 306 and 312.

Then, when the display image 450 is displayed,

a thumbnail of any one of the input images 302, 308, 309 and 312 is displayed in the divided display area DS₄,

a thumbnail of any one of the input images 302, 303, 304 and 312 is displayed in the divided display area DS₂,

a thumbnail of any one of the input images 302, 303 and 304 is displayed in the divided display area DS₆, and

a thumbnail of any one of the input images 302, 303, 304, 305, 306 and 312 is displayed in the divided display area DS₈.

The thumbnails of the input images 302, 303, 304 and 312 are candidates of the thumbnail to be displayed in the divided display area DS₂ of the display image 450. If there are a plurality of candidates of the thumbnail to be displayed in the divided display area DS₂ of the display image 450, the input images corresponding to the candidate of the thumbnails are regarded as the candidate input images, and priority orders are assigned to the candidate input images based on levels of the first similarities between the reference image and the candidate input images. Then, the thumbnail of the candidate input image having the highest priority order is displayed in the divided display area DS₂ of the display image 450. It is preferable to determine the above-mentioned distance (Euclidean distance) between the characteristic vector of the reference image and the characteristic vector of the candidate input image for each candidate input image and to assign higher priority order to the candidate input image having smaller distance. When the thumbnail of the candidate input image having the highest priority order is displayed in the divided display area DS₂, if the user performs a predetermined left direction selection operation (e.g., presses down a left direction key in a cross key of the operating unit 20), the thumbnail that is displayed in the divided display area DS₂ is switched to the thumbnails of the candidate input images having the priority order of the second, the third, and so on in this order.

Similarly, if there are a plurality of candidates of the thumbnail to be displayed in the divided display area DS₆ of the display image 450, the input image corresponding to the candidates of the thumbnails are regarded as the candidate input images, and priority orders are assigned to the candidate input images based on levels of the fourth similarities between the reference image and the candidate input images. Then, the thumbnail of the candidate input image having the highest priority order is displayed in the divided display area DS₆ of the display image 450. It is preferable to determine the image sensing time difference between the reference image and the candidate input image for each candidate input image and to assign higher priority order to the candidate input image having smaller image sensing time difference. When the thumbnail of the candidate input image having the highest priority order is displayed in the divided display area DS₆, if the user performs a predetermined lower direction selection operation (e.g., presses down a lower direction key in a cross key of the operating unit 20), the thumbnail that is displayed in the divided display area DS₆ is switched to the thumbnails of the candidate input images having the priority order of the second, the third, and so on in this order.

Similarly, if there are a plurality of candidates of the thumbnail to be displayed in the divided display area DS₈ of the display image 450, the input image corresponding to the candidates of the thumbnails are regarded as the candidate input images, and priority orders are assigned to the candidate input images based on levels of the fifth similarities between the reference image and the candidate input images. Then, the thumbnail of the candidate input image having the highest priority order is displayed in the divided display area DS₈ of the display image 450. It is preferable to determine the image sensing position difference between the reference image and the candidate input image for each candidate input image and to assign higher priority order to the candidate input image having smaller image sensing position difference. When the thumbnail of the candidate input image having the highest priority order is displayed in the divided display area DS₈, if the user performs a predetermined right direction selection operation (e.g., presses down a right direction key in a cross key of the operating unit 20), the thumbnail that is displayed in the divided display area DS₈ is switched to the thumbnails of the candidate input images having the priority order of the second, the third, and so on in this order.

If there are a plurality of candidates of the thumbnail to be displayed in the divided display area DS₄ of the display image 450, a thumbnail selected freely from the candidates can be displayed in the divided display area DS₄. In other words, in the above-mentioned example, any thumbnail among the thumbnails of the input images 302, 308, 309 and 312 can be displayed in the divided display area DS₄. It is because that a level of the third similarity with the reference image is the same among the input images 302, 308, 309 and 312 (see FIGS. 9 and 11). It is possible to regard each of the input images 302, 308, 309 and 312 as the candidate input image and to display the thumbnail of the candidate input image having the smallest image sensing time difference between the reference image and the candidate input image in the divided display area DS₄ of the display image 450. Otherwise, it is possible to switch the thumbnail that is displayed in the divided display area DS₄ among the thumbnails of the input images 302, 308, 309 and 312 in accordance with a predetermined upper direction selection operation of the user.

Further, if there are a plurality of input images having high third similarity with the reference image, the thumbnails of the plurality of input images may be overlaid and displayed in the divided display area DS₄ in accordance with the method illustrated in FIG. 18. The same is true for the divided display areas DS₂, DS₆ and DS₈ corresponding to the first, the fourth and the fifth similarities. However, when a plurality of thumbnails are overlaid and displayed in the divided display area DS₂, it is preferable to dispose the thumbnail of the input image having higher first similarity with the reference image on the upper layer (the same is true for the divided display areas DS₆ and DS₈).

By the above-mentioned reproduction operation, the input images that are considered to have high relevance to the reference image are displayed as one display for user's convenience.

### Fourth Embodiment

The fourth embodiment of the present invention will be described. In the first to third embodiments, a reproduction medium for the n output images selected by the image selection unit 31 is the display screen 19a. However, the reproduction medium may not the display screen 19a but paper, for example. If the reproduction medium is paper, the imaging apparatus 1 is connected to a printer (not shown), and a reproduction signal is sent from the layout generation unit 32 to the printer so that desired printing is performed.

A mode to output the images to paper as the reproduction medium, i.e., a mode of printing the images on paper is referred to as a print mode. The print mode is one type of the reproduction mode. In the fourth embodiment, an operation of the imaging apparatus 1 in the print mode will be described as follows.

When the user specifies the m input images recorded in the recording medium 17 as reproduction objects (i.e., print objects) in the state where the reproduction object selection function is enabled, the image selection unit 31 selects the n output images from the m input images. After this selection, the layout generation unit 32 generates a print layout and delivers to the printer the reproduction signal for printing the n output images on paper in accordance with the generated print layout. The selection method of the output images is as described above in the first embodiment.

The print layout is determined in accordance with the user's specifying operation. For instance, the user can specify a first print layout for printing only one output image on one paper sheet, a second print layout for printing k output images aligned in the vertical and/or the horizontal directions on one paper sheet, or a third print layout for printing k output images in accordance with a predetermined arrangement rule on one paper sheet. As described above, k is an integer of two or larger, and n≧k holds.

When the first print layout is specified, the layout generation unit 32 generates and outputs the reproduction signal so that the n output images are printed on n paper sheets one on one sheet.

When the second or the third print layout is specified, the layout generation unit 32 generates and outputs the reproduction signal so that the k output images are printed on one paper sheet. Therefore, as the n output images include the first to the n-th output images, the first to the k-th output images are printed on the first paper sheet, the (k+1)th to the (2×k)th output images are printed on the second paper sheet. The same is true for the third and succeeding paper sheets. As a matter of course, if “n≦k” holds, printing is not performed for the second and succeeding paper sheets. If “n≦(2×k)” holds, printing is not performed for the third and succeeding paper sheets. In addition, if n cannot be divided by k, the number of output images to be printed on the last paper sheet is the remainder when n is divided by k.

For instance, as the example described above in the first embodiment, it is supposed that the input images 301, 303, 304, 305, 307, 308, 309, 310 and 312 are selected as the n output images from the input images 301 to 312 and that k=6 holds. Under this supposition, when the second or the third print layout is specified, the input images 301, 303, 304, 305, 307 and 308 as the first to the sixth output images are printed on the first paper sheet, and the input images 309, 310 and 312 as the seventh to the ninth output images are printed on the second paper sheet.

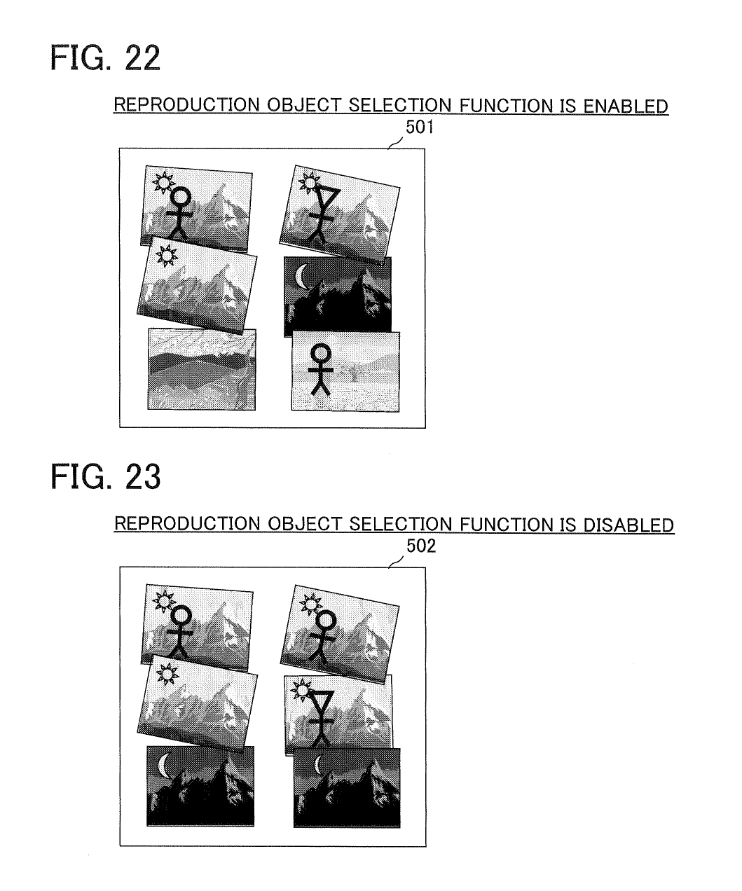

FIG. 22 illustrates the print state on the first paper sheet 501 when the printing is performed in accordance with the third print layout under this supposition. The paper sheet 501 is used for printing in the state where the reproduction object selection function is enabled. The input images 301, 303, 304, 305, 307 and 308 are printed as the first to the sixth output images on the paper sheet 501 (see FIG. 11). Further, when the printing with the third print layout is performed in the state where the reproduction object selection function is disabled, the print as illustrated in FIG. 23 is performed on the first paper sheet 502. The input images 301 to 306 are printed on the paper sheet 502. In the state where the reproduction object selection function is disabled, similar images may be printed in an overlapping manner, so that contents of the display may become redundant.

In the second print layout, a plurality of output images are arranged so that different output images are not overlapped with each other on the paper to print. In the third print layout, however, as illustrated in FIGS. 22 and 23, different output images can be overlapped with each other on the paper. The user can set freely a layout position and a size of the output image on the paper.

According to the fourth embodiment, printing of an image that is similar to the actually printed image or an image of low importance is omitted, so that redundancy of contents of a print can be suppressed.

### Fifth Embodiment

A fifth embodiment of the present invention will be described. The above-mentioned processes based on the record data in the recording medium 17 may be performed by electronic equipment different from the imaging apparatus (e.g., the image reproducing apparatus that is not shown) (the imaging apparatus is a type of the electronic equipment).

For instance, the imaging apparatus 1 obtains a plurality of input images by image sensing and records the image file storing the image data of the input images and the above-mentioned additional data in the recording medium 17. Further, the above-mentioned electronic equipment is provided with the reproduction control unit 22, and the record data in the recording medium 17 is supplied to the reproduction control unit 22 in the electronic equipment. Thus, the reproduction by display or the reproduction by print described above in the embodiments can be realized. Note that it is possible to dispose in the electronic equipment a display unit similar to the display unit 19, and it is possible to dispose in the electronic equipment an image analysis unit similar to the image analysis unit 14, if necessary.

### Sixth Embodiment

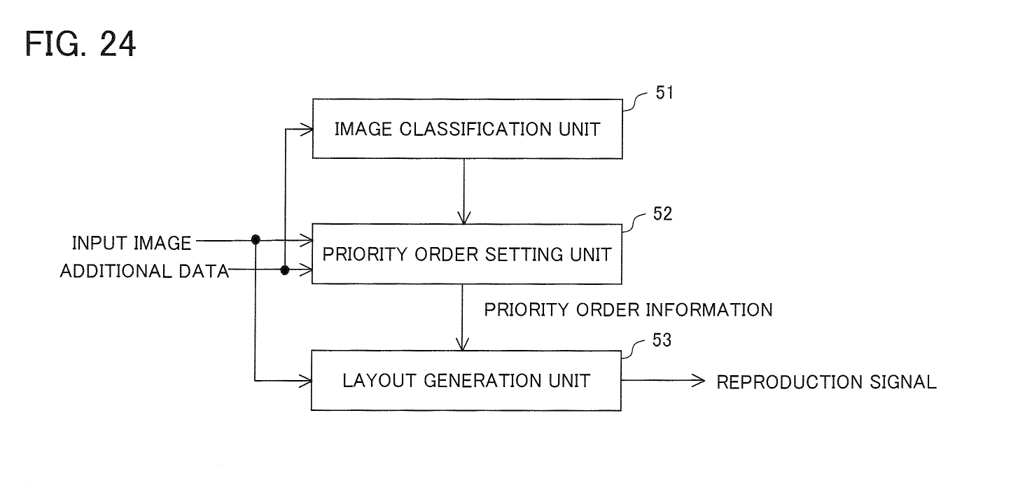

A sixth embodiment of the present invention will be described. FIG. 24 is a block diagram of a part related particularly to an operation of the sixth embodiment. An image classification unit 51, a priority order setting unit 52 and a layout generation unit (image output unit) 53 are, for example, disposed in the reproduction control unit 22 illustrated in FIG. 1. However, the image classification unit 51 and the priority order setting unit 52 may be disposed in the image analysis unit 14 illustrated in FIG. 1.

The image classification unit 51, the priority order setting unit 52 and the layout generation unit 53 work significantly in the reproduction mode. Therefore, the following description about the image classification unit 51, the priority order setting unit 52 and the layout generation unit 53 is basically a description of them in the reproduction mode. However, in this embodiment, the operation of the imaging apparatus 1 in the image sensing mode is also described as necessary. The image data of the input image and the additional data read out from the recording medium 17 are supplied to the entire or a part of the image classification unit 51, the priority order setting unit 52 and the layout generation unit 53.

The image classification unit 51 is constituted to be capable of realizing all the functions that the image selection unit 31 of the first embodiment (see FIG. 8) can realize. Therefore, the image classification unit 51 can evaluate similarity between any different input images in the m input images, similarly to the image selection unit 31, based on the additional data of the m input images (see FIG. 3) and further by using image data of the m input images, if necessary.

In the first to the fifth embodiments described above, the operation in the case where the reproduction object selection function is enabled is mainly described (see FIG. 12 and the like). In the sixth embodiment, however, it is supposed that the reproduction object selection function is disabled. However, it is possible to set the reproduction object selection function to be enabled and supplies the m input images read out from the recording medium 17 to the image selection unit 31 illustrated in FIG. 8 so as to regard the n output images output from the image selection unit 31 new m input images and supplied the same to the priority order setting unit 52 and the layout generation unit S3 (and the image classification unit 51).

The similarities to be evaluated by the image classification unit 51 include the first to the fifth similarities (see FIG. 9). The image classification unit 51 adopts one or more similarities as the selection index similarities among the first to the fifth similarities, and classifies the m input images into a plurality of categories based on a level of the selection index similarity. By this classification, each of the input images is classified into one of the plurality of categories. For instance, if only the first and the second similarities are used as the selection index similarities, the above-mentioned classification is performed based on only the first and the second similarities without considering levels of the third to the fifth similarities. It is preferable that the selection index similarities include at least the first similarity.

As described above in the first embodiment, to decide that all the selection index similarities are high among the noted plurality of input images is referred to as similarity decision for convenience sake. In addition, to decide that one or more selection index similarities are low among the noted plurality of input images is referred to as non-similarity decision for convenience sake. If the similarity decision is made between the first and the second input images, the first and the second input images are classified into the same category. If the non-similarity decision is made between the first and the second input images, the first and the second input images are classified into different categories. In other words, considering the case where the one-piece selection or the whole selection is performed between the first and the second input images in accordance with the method described above in the first embodiment (see FIG. 10), under the situation where the one-piece selection is made between the first and the second input images, the first and the second input images are classified into the same category. On the other hand, under the situation where the whole selection is made between the first and the second input images, the first and the second input images are classified into different categories.

The image classification result by the image classification unit 51 is transmitted to the priority order setting unit 52. The priority order setting unit 52 performs a priority order setting process of setting priority orders to the input images belonging to the category based on the image data of the m input images and the additional data corresponding to the m input images. The priority order setting process is performed for each category. However, if only one input image belongs to a certain category, it is not necessary to assign the priority order, and the priority order of the one input image is naturally the first order. It is supposed that the highest priority order is the first order and that the priority order descends in the order of the first, the second, the third, and so on. Therefore, the priority order of the input image in the i-th order is higher than that of the input image in the (i+1) the order (i is an integer). Information indicating the priority order set by the priority order setting unit 52 is referred to as priority order information.

The layout generation unit 53 has a function similar to the layout generation unit 32 illustrated in FIG. 8. The layout generation unit 53 generates a layout of the display screen 19a (see FIG. 6) based on a type of the reproduction mode (e.g., based on which of the slide show mode and the thumbnail display mode the reproduction mode specified by the user is), and outputs to the display unit 19 a reproduction signal for reproducing and displaying the m input images on the display screen 19a in accordance with the generated layout. In this case, the layout generation unit 53 determines display positions and display orders of the input images based on the priority order information.

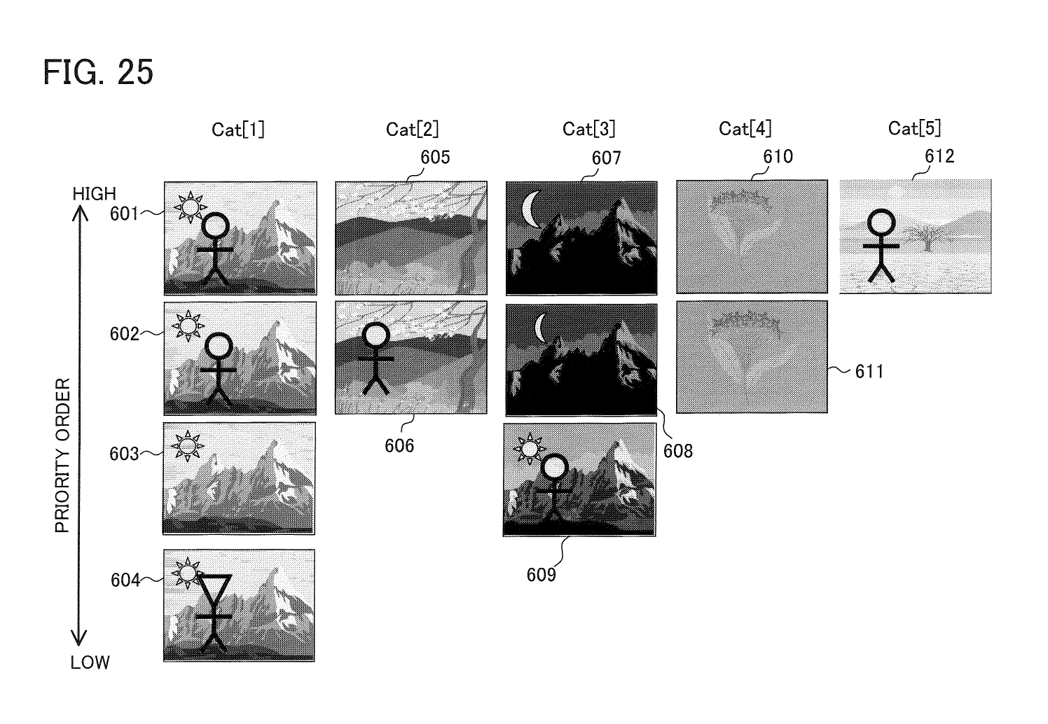

For a specific description, it is supposed that the m input images to be classified include twelve input images 601 to 612 illustrated in FIG. 25. In addition, it is supposed that the image classification unit 51 classifies the input images 601 to 604 into a category Cat[1], classifies the input images 605 and 606 into a category Cat[2], classifies the input images 607 to 609 into a category Cat[3], classifies the input images 610 and 611 into a category Cat[4], and classifies the input image 612 into a category Cat[5]. If i and j are different integers, categories Cat[i] and Cat[j] are different categories.

The priority order setting unit 52 sets priority orders of the input images 601 to 604 belonging to the category Cat[1] based on the image data and the additional data of the input images 601 to 604. Similarly, priority orders of the input images 605 and 606 belonging to the category Cat[2] are set based on the image data and the additional data of the input images 605 and 606. The same is true for the categories Cat[3] and Cat[4].

It is supposed that the first to the fourth orders are assigned respectively to the input images 601 to 604 in the category Cat[1], the first and the second orders are assigned respectively to the input images 605 and 606 in the category Cat[2], the first to the third orders are assigned respectively to the input images 607 to 609 in the category Cat[3], and the first and the second orders are assigned respectively to the input images 610 and 611 in the category Cat[4]. Since only the input image 612 belongs to the category Cat[5], the priority order of the input image 612 is naturally the first order.

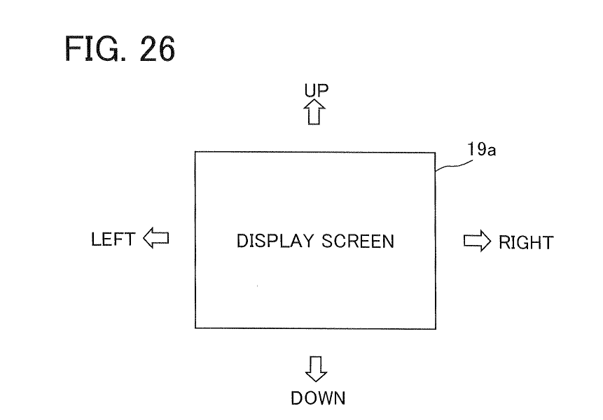

Note that up, down, left and right directions are defined with respect to the display screen 19a, as illustrated in FIG. 26. In the display screen 19a, the up and down direction corresponds to the vertical direction of the display screen 19a and the input image, while the left and right direction corresponds to the horizontal direction of the display screen 19a and the input image. If the imaging apparatus 1 is held by the hand of the user, the lower display area of the display screen 19a is usually positioned closer to the ground than the upper display area of the display screen 19a.

The priority order setting unit 52 sets the priority orders to the input images so that a higher priority order is assigned to an input image that is estimated to be more important (e.g., an input image that is estimated to have higher degree of being desired to see) for the user (audience). Details of the setting method of the priority orders will be described later, and before that, a display method of the input image using the layout generation unit 53 will be described. The reproduction modes are classified into a plurality of modes, and the plurality of modes includes a list display mode, a thumbnail display mode and a slide show mode. The user can specify the mode in which the input images are displayed by using the operating unit 20 or the like. The display method in each mode will be described individually.

[List Display Mode]

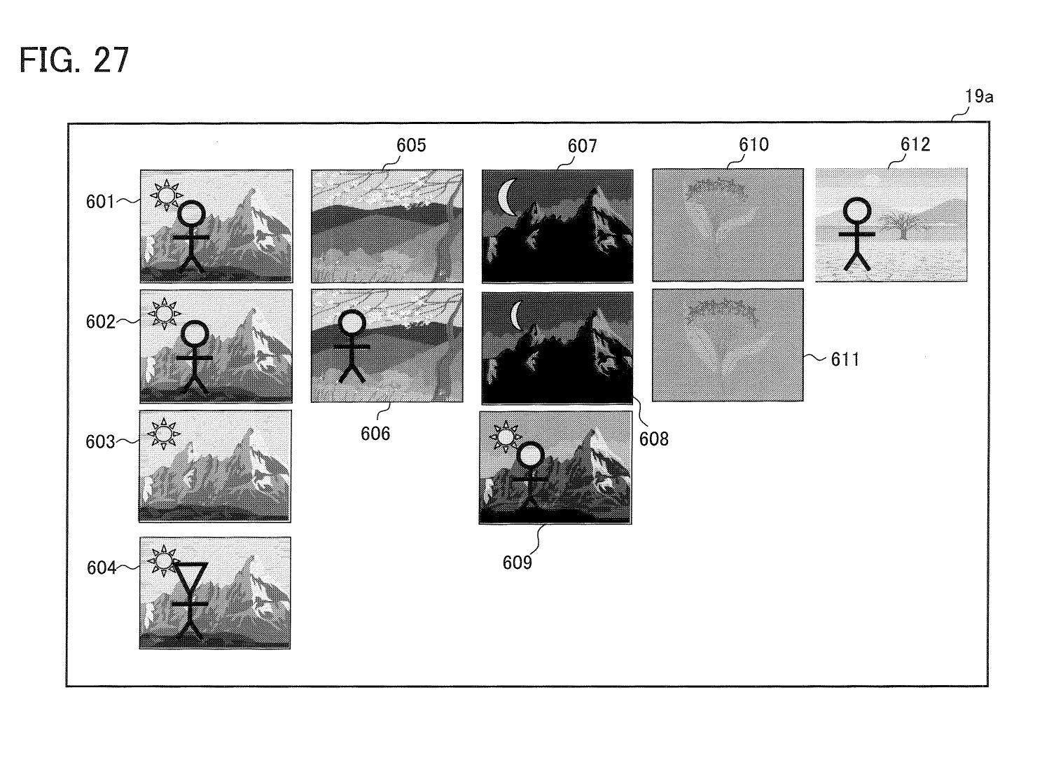

The display method in the list display mode will be described. FIG. 27 illustrates an example of display screen 19a in the list display mode. In the list display mode, input images belonging to the same category are aligned in the up and down direction and are displayed, and input images belonging to different categories are aligned in the left and right direction and are displayed. In this case, the layout generation unit 53 determines display positions of the input images so that an input image having a higher priority order is displayed at an upper position based on the priority order information.

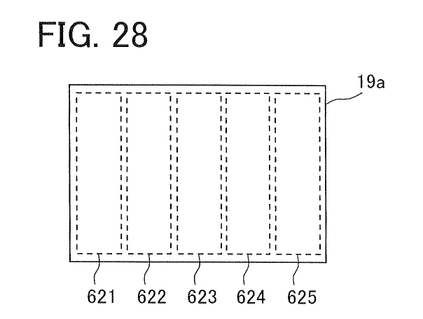

Therefore, when the input images 601 to 612 are displayed in the list display mode, as illustrated in FIG. 28, the entire display area of the display screen 19a are divided into five category display areas 621 to 625 by four boundary lines that are parallel and extend in the up and down direction, in which one category is assigned to one category display area. It is arbitrary which category is assigned to which category display area. Here, it is supposed that the categories Cat[1] to Cat[5] are assigned to the category display areas 621 to 625, respectively. Then, the input images belonging to the categories Cat[1] to Cat[5] are displayed in the category display areas 621 to 625, respectively.

More specifically, the input images 601 to 604 are displayed in the category display area 621, the input images 605 and 606 are displayed in the category display area 622, the input images 607 to 609 are displayed in the category display area 623, the input images 610 and 611 are displayed in the category display area 624, and the input image 612 is displayed in the category display area 625. In this case, in accordance with the priority order information, the input images 601 to 604 are aligned from up to down in the category display area 621, and the input images 605 and 606 are aligned from up to down in the category display area 622. The same is true for the category display areas 623 and 624. The only one input image 612 belonging to the category Cat[5] is displayed in the category display area 625.

The user can select any of input images displayed on the display screen 19a by the selection operation. When the selection operation is performed, the selected input image is displayed in an enlarged manner in the entire display screen 19a (the same is true for the thumbnail display mode that will be described later). The user can perform the selection operation by using the operating unit 20 or the like.

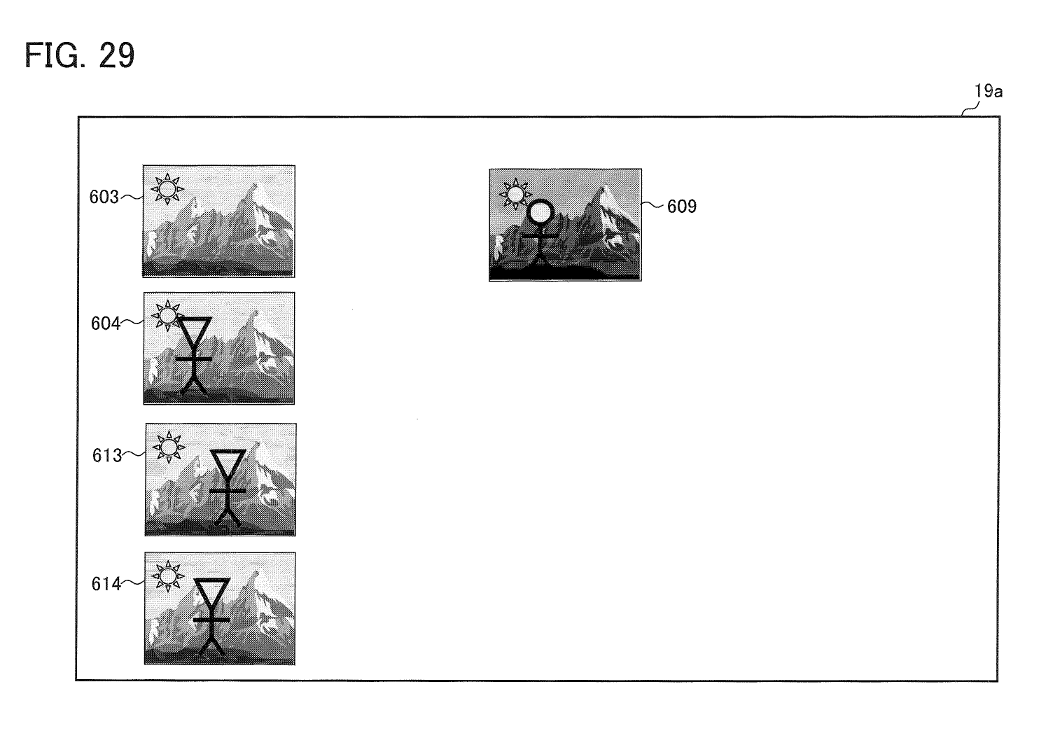

The upper limit number of input images that can be displayed in one category display area is fixed. This upper limit number can be set to any number, but it is supposed that the upper limit number is four. Then, as illustrated in FIG. 27, the input images 601 to 612 are displayed on the display screen 19a at the same time without overlapping with each other. It is supposed that the m input images include the input images 601 to 612 and the input images 613 and 614, and that the input images 613 and 614 belong to the category Cat[1], and that the priority orders of the input images 613 and 614 are the fifth and the sixth orders. Then, only the input images 601 to 612 having the priority order that is one of the first to the fourth orders are first displayed (i.e., the display screen 19a is as illustrated in FIG. 27 first). In this state, if a predetermined scroll operation is performed to the operating unit 20 or the like, the input images 613 and 614 are displayed as illustrated in FIG. 29 (as a result, in this case, the m input images are displayed in a plurality of times). In this case, the input images (603 and the like) having higher priority order than the fifth order may be displayed together with the input images 613 and 614. FIG. 29 illustrates an example of the display screen 19a after the scroll operation.

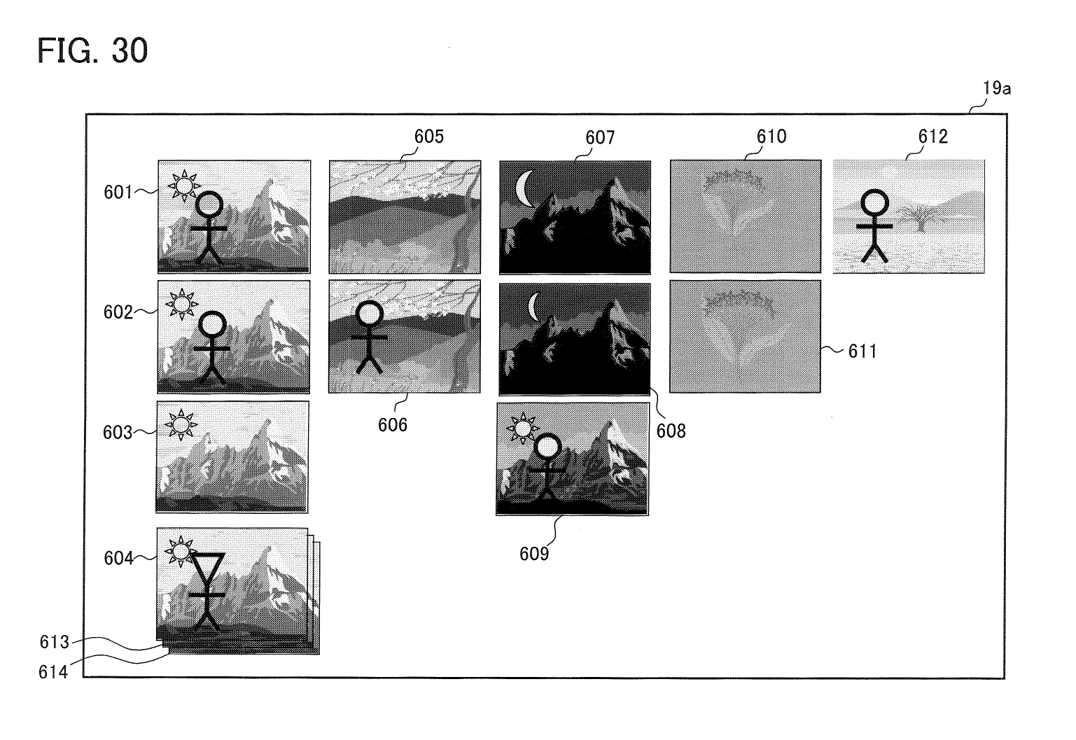

Alternatively, as illustrated in FIG. 30, it is possible to constitute the display screen 19a as illustrated in FIG. 30 regardless of presence or absence of the scroll operation. In the display screen 19a illustrated in FIG. 30, a part of the input images 613 and 614 is disposed under the input image 604, and in this state the input images 613 and 614 are displayed together with the input images 601 to 612 simultaneously. In the display screen 19a illustrated in FIG. 30, the user cannot see the image portion of the input images 613 and 614 disposed under the input image 604. In this state, only if the user performs a predetermined operation for selecting the input image 613 or 614 to the operating unit 20 or the like, the entire of the input image 613 or 614 is displayed on the display screen 19a. In FIG. 30, instead of the display of the input images 613 and 614 with being disposed under the input image 604, simple rectangular frames or the like that are not based on the image data of the input images 613 and 614 may be arranged to the input image 604 for displaying. In this way, too, the user can know that there are the input images 613 and 614.

The case where the number of the category display areas is five is exemplified above, but the number is not limited to five. In the list display mode, the display method of the plurality of input images belonging to the same category can be changed variously. For instance, the method of setting the category display areas elongated in the vertical direction so that the plurality of input images belonging to the same category are aligned in the up and down direction in accordance with the priority order information for displaying is exemplified above, but a method may be adopted in which category display areas elongated in the horizontal direction are set, so that the plurality of input images belonging to the same category are aligned in the left and right direction in accordance with the priority order information for displaying. In this case, display positions of the input images are determined so that an input image having a higher priority order is displayed closer to the left end (or to the right end) in the display screen 19a.

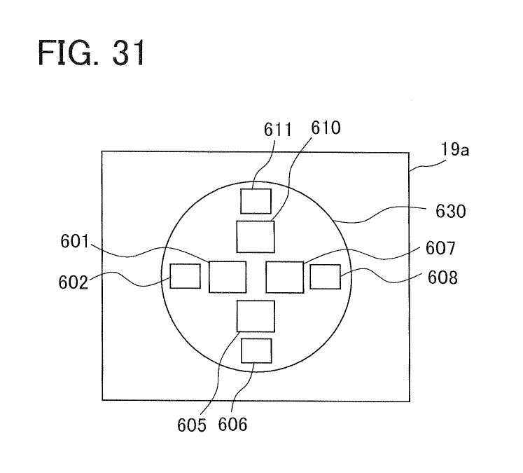

Alternatively, a plurality of input images belonging to the same category are arranged and displayed in a radial manner in accordance with the priority order information. In this case, display positions of the input images are determined so that an input image having a higher priority order is displayed closer to the radial center on the display screen 19a. The method of arranging in a radial manner for the display is useful in the case where the input images are glued onto a spherical surface 630 in the image space (see FIG. 31) for displaying or other case. FIG. 31 illustrates an example of the display screen 19a in the case where the input images belonging to the categories Cat[1] to Cat[4] are glued onto the spherical surface 630 for displaying. To avoid complication of the drawing, the input images are illustrated by simple rectangular frames in FIG. 31. On the display screen 19a, from the center portion of the spherical surface 630 to the left direction, to the lower direction, to the right direction and to the upper direction, the input images belonging respectively to the categories Cat[1] to Cat[4] are arranged. In this case, display positions of the input images are determined so that an input image having a higher priority order is displayed closer to the center portion of the spherical surface 630. It is preferable to provide a touch panel function to the display screen 19a. The user can rotate a spherical surface 630 in a desired direction by the touch panel operation. When this rotation is performed, the input image that can be viewed and recognized on the display screen 19a is changed. For instance, although the input image 603 cannot be viewed and recognized before the rotation as illustrated in FIG. 31, after the rotation the input image 603 can be viewed and recognized (not shown). Note that the input images displayed on the display screen 19a in the list display mode may be thumbnails of the input images.

According to this list display mode, the input images are displayed on the display screen 19a in the order from one having higher priority order (e.g., the input image having higher priority order is displayed closer to the upper region of the display screen 19a). Therefore, the user can view, find and select easily an input image that is estimated to be more important (e.g., an input image that is estimated to have higher degree of being desired to see).

For instance, it is supposed that the m input images include 20 target input images obtained by image sensing similar landscapes, and that the tenth target input image among the 20 target input images is the most important input image for the user (e.g., the best focused input image). In this case, if the m input images (e.g., 100 input images) including the 20 target input images are simply arranged in file number order for the display, the user who wants to view or select the tenth target input image is required to find the tenth target input image from many input images by using the scroll operation or the like. However, according to this list display mode, a higher priority order is assigned to the tenth target input image that is estimated to be more important so as to display the same with a high priority. Therefore, the user can perform viewing or the like of the tenth target input image easily.

[Thumbnail Display Mode]

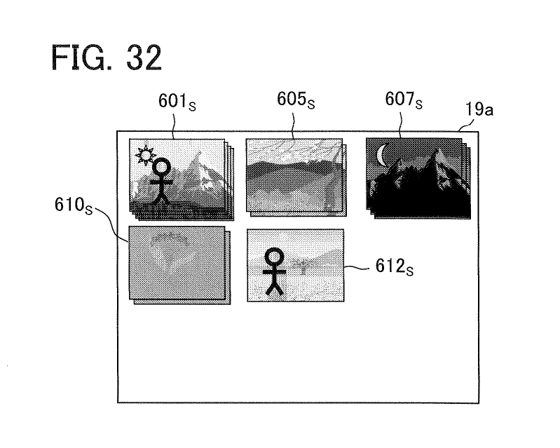

A display method in the thumbnail display mode will be described. FIG. 32 illustrates an example of the display screen 19a in the thumbnail display mode. In the thumbnail display mode, first, the input image having the priority order of the first order is selected from each category, and thumbnails of the selected input images are arranged and displayed on the display screen 19a simultaneously. This display state is referred to as an initial display state for a convenience sake. FIG. 32 illustrates an example of a display screen 19a of the initial display state.

In the initial display state, the nine divided display areas DS₁ to DS₉ are set in the entire display area DW of the display screen 19a (see FIG. 7), and thumbnails of the input images having the first order belonging respectively to the categories Cat[1], Cat[2], Cat[3], Cat[4] and Cat[5] are displayed in the divided display areas DS₁, DS₄, DS₇, DS₂ and DS₅ (or, thumbnail of the input image of the first order belonging to the category Cat[i] may be displayed in the divided display area DS;). In other words, in the initial display state, a thumbnail 601_{S} of the input image 601, a thumbnail 605_{S} of the input image 605, a thumbnail 607_{S} of the input image 607, a thumbnail 610_{S} of the input image 610 and a thumbnail 612_{S} of the input image 612 are displayed in the divided display areas DS₁, DS₄, DS₇, DS₂ and DS₅, respectively. Note that the number of the divided display area is nine in the example illustrated in FIG. 32, the number is not limited to nine.

In the initial display state, thumbnails of the input images having priority orders other than the first order are not displayed at all or only some of them are displayed. In the example illustrated in FIG. 32, in the initial display state, thumbnails of the input images having priority orders other than the first order are partially displayed. In other words, a part of each thumbnail of the input images 602 to 604 is disposed under the thumbnail 601_{S} and is displayed. Similarly, a part of thumbnail of the input image 606 is disposed under the thumbnail 605_{S} and is displayed. The same is true for a thumbnail of the input image 608 or the like. In the display screen 19a illustrated in FIG. 32, the user cannot see the image portion disposed under the thumbnail 601_{S} among thumbnails of the input images 602 to 604. The same is true for the thumbnail of the input image 606 or the like. In FIG. 32, instead of the display of the thumbnails of the input images 602 to 604 with being disposed under the thumbnail 601_{S}, simple rectangular frames or the like that are not based on the image data of the input images 602 to 604 may be arranged to the thumbnail 601_{S} for displaying. In this way, too, the user can know that there are the input images 602 to 604 (the same is true for the input image 606 or the like).

In the initial display state, only if a predetermined operation is performed to the operating unit 20 or the like, the entire image of the thumbnail of the input image having the second order or lower priority order is displayed. For instance, every time when the predetermined operation is performed once from the initial display state as a start point, the thumbnails of the input images displayed on the display screen 19a are changed to those of the second order, those of the third order, those of the fourth order, and so on sequentially, and at the end the initial display state appears again. In this way, in the thumbnail display mode, m input images (actually, thumbnails of them) are displayed in a plurality of times.

According to this thumbnail display mode, thumbnails of the input images are displayed on the display screen 19a in the order from one having higher priority order. Therefore, the user can view, find and select easily an input image that is estimated to be more important (e.g., an input image that is estimated to have higher degree of being desired to see).

[Slide Show Mode]

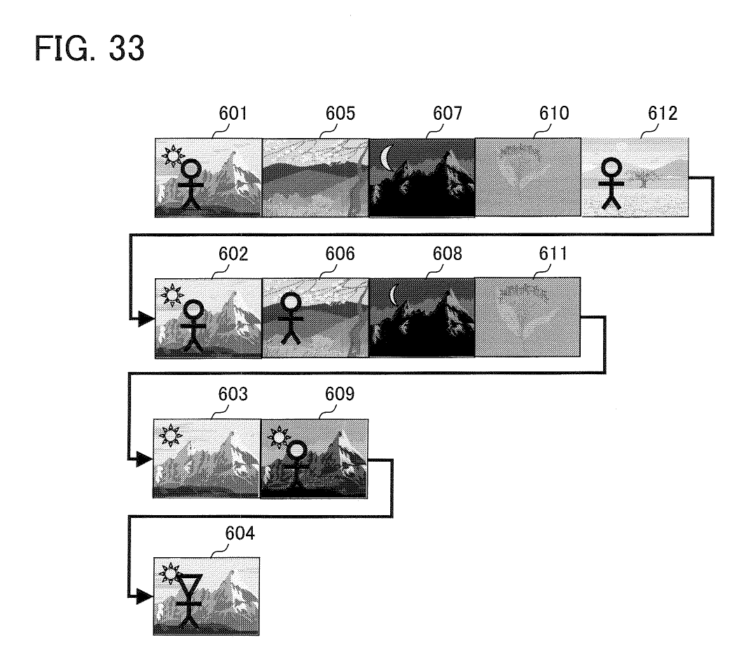

A display method in the slide show mode will be described. FIG. 33 is a diagram illustrating contents of a display when the slide show is performed. In the slide show mode, the layout generation unit 53 illustrated in FIG. 24 (or the reproduction control unit 22 illustrated in FIG. 1) displays the input images one by one on the display screen 19a so that the input image of the i-th order is displayed earlier than the input image of the (i+1)th order. This is true regardless whether or not the category is the same. In other words, the input image of the i-th order belonging to a certain category is displayed earlier than the input image of the (i+1)th order belonging to the same category and the input image of the (i+1)th order belonging to another category.

Therefore, if the operation in the slide show mode is performed with respect to the input images 601 to 612, as illustrated in FIG. 33, the input images 601, 605, 607, 610, 612, 602, 606, 608, 611, 603, 609 and 604 are displayed in this order one by one at a constant time interval. When a constant time passes from the display of the input image 604, the same display is performed again from the input image 601 sequentially.

In addition, in the above-mentioned description, the input images are displayed one by one sequentially on the display screen 19a in the slide show mode. However, it is possible to adopt a configuration in which the input image are displayed sequentially a plurality of images at one time on the display screen 19a. For instance, it is possible to adopt the following display method. When the operation in the slide show mode is performed with respect to the input images 601 to 612, the input images 601, 605, 607, 610 and 612 having the first order are first aligned horizontally or vertically and are displayed on the display screen 19a simultaneously at the first timing, the input images 602, 606, 608 and 611 having the second order are aligned horizontally or vertically and are displayed on the display screen 19a simultaneously at the second timing, the input images 603 and 609 having the third order are aligned horizontally or vertically and are displayed on the display screen 19a simultaneously at the third timing, and the input image 604 having the fourth order is displayed on display screen 19a at the fourth timing. After that, the same display operation as the first timing and the succeeding timings is repeated. Here, the (i+1) timing is a timing after the i-th timing (i is an integer). Note that the input images displayed on the display screen 19a in the slide show mode may be thumbnails of the input images.

According to the slide show mode, the input images are displayed on the display screen 19a in the order from one having higher priority order. Therefore, the user can view earlier the input image that is estimated to be more important (e.g., an input image that is estimated to have higher degree of being desired to see).

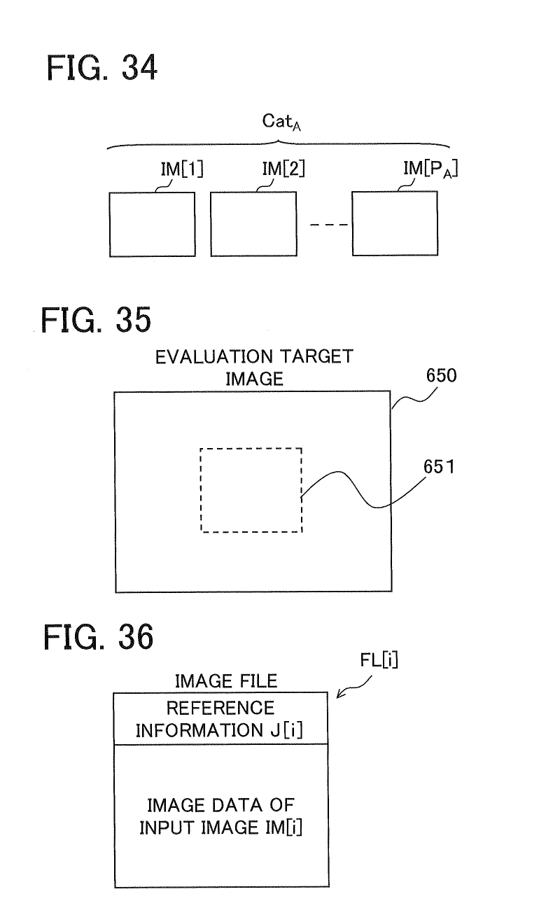

Next, an example of the setting method of the priority orders by the priority order setting unit 52 will be described. For convenience sake of description, a category Cat_{A} that is one category Cat[i] is noted, and the setting method of the priority orders with respect to the category Cat_{A} will be described. As illustrated in FIG. 34, it is supposed that P_{A} input images IM[1] to IM[P_{A}] belong to the category Cat_{A} (P_{A} is an integer of two or larger). In addition, it is supposed that image sensing time of the input image IM[i+1] is later than that of the input image IM[i], and that the priority order setting unit 52 recognizes a temporal order of the image sensing times of the input images IM[1] to IM[P_{A}] based on the time stamp information of the input images IM[1] to IM[P_{A}]. As an example of the setting method of the priority orders that the priority order setting unit 52 can adopt, first to twelfth priority order setting methods will be exemplified individually as follows.

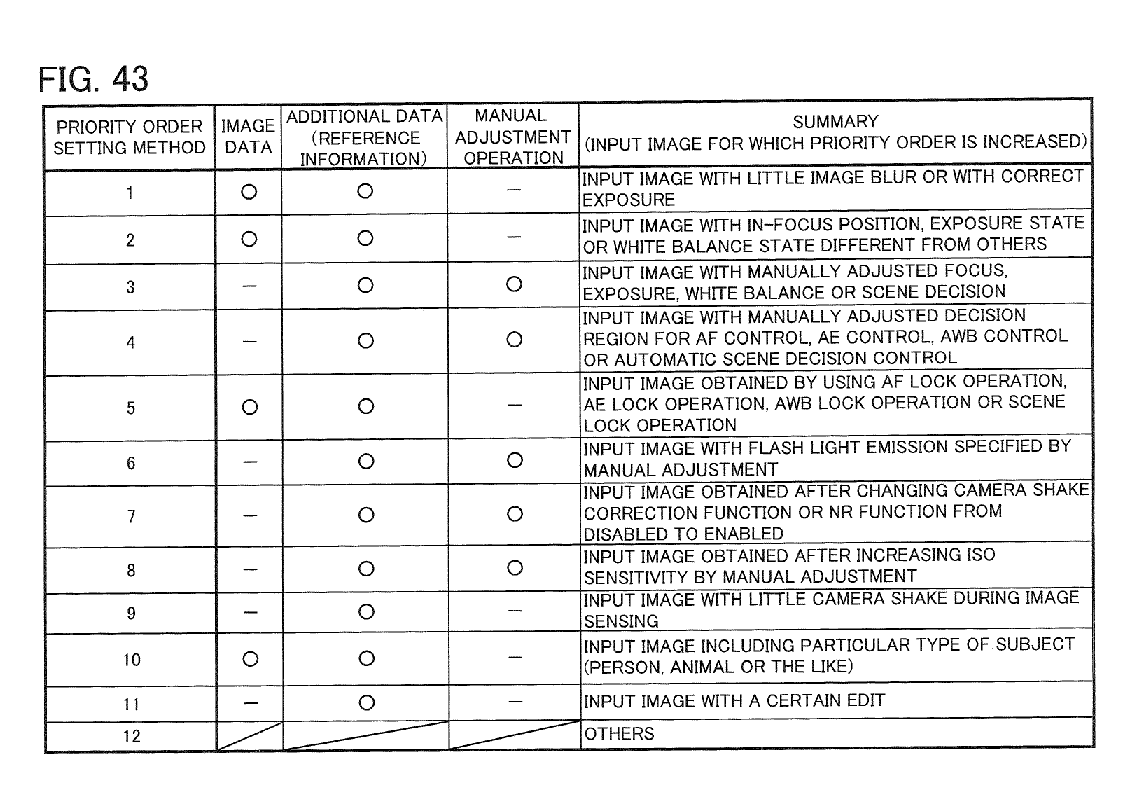

FIG. 43 illustrates a general outline of the first to twelfth priority order setting methods (general outline of the input images having enhanced priority order). FIG. 43 also illustrates first to third items related to realizing the priority order setting methods. The first item is an item as image data, the second item is an item as an additional data, and the third item is an item as a manual adjustment operation. In the table illustrated in FIG. 43, if a circle is marked in a field of the i-th priority order setting method and the first item, it means that the i-th priority order setting method can be realized based on the image data of the input image. If a circle is marked in a field of the i-th priority order setting method and the second item, it means that the i-th priority order setting method can be realized based on the additional data of the input image (more specifically, for example, the reference information J[i] that will be described later). If a circle is marked in a field of the i-th priority order setting method and the third item, it means that the i-th priority order setting method can be realized based on presence or absence of manual adjustment operation that will be described later. However, FIG. 43 is provided for convenience of understanding contents of the first to twelfth priority order setting methods, and contents of the priority order setting methods comply with the description that will be described later.

Note that, if no contradiction arises, a plurality of priority order setting methods may be combined for setting the priority orders. It is possible to use one priority order setting method for setting a part of priority orders of the input images IM[1] to IM[P_{A}] and to use another priority order setting method for setting the rest of the priority orders. The process necessary for realizing the priority order setting methods is performed in the priority order setting unit 52, but the process may be performed in other part than the priority order setting unit 52 (e.g., the image analysis unit 14 or the main control unit 21 illustrated in FIG. 1).

[First Priority Order Setting Method]

A first priority order setting method will be described. In the first priority order setting method, a higher priority order is assigned to an input image having less image blur. It is because that an input image with less image blur is estimated to be more important for the user than an input image with more.

Specifically, for example, the priority order can be determined by the following computation. The input image IM[i] is regarded as an evaluation target image 650, and an evaluation region 651 is set in the evaluation target image 650 as illustrated in FIG. 35. The evaluation region 651 is a part of the entire image area of the evaluation target image 650. However, the entire image area itself of the evaluation target image 650 may be set as the evaluation region 651. In addition, the evaluation region 651 is a rectangular region in FIG. 35, but the evaluation region 651 is not limited to the rectangular region.

An AF score calculation unit (not shown) disposed in the priority order setting unit 52 or the image analysis unit 14 calculates an AF score having a value corresponding to contrast of the image inside the evaluation region 651 by using a high pass filter or the like based on the image data in the evaluation region 651. The AF score increases along with an increase of contrast of the image in the evaluation region 651. Such a calculation of the AF score is performed for each of the input images IM[1] to IM[P_{A}]. Usually, as the image blur is less, the contrast of the image increases, and the corresponding AF score is also increased. Therefore, the priority orders of the input images should be determined so that a higher priority order is assigned to an input image having a higher AF score based on the AF score calculated for the input images IM[1] to IM[P_{A}]. Note that the “image blur” has the same meaning as the “blur amount of image” described above in the first embodiment. For instance, the above-mentioned AF score is equivalent to the blur amount score described above in the first embodiment. Therefore, the blur amount score of each input image may be calculated as the AF score in accordance with the method described above in the first embodiment.

Alternatively, it is possible to assign a higher priority order to an input image with a more appropriate exposure. It is because that an input image with more appropriate exposure is estimated to be more important for the user than that with inappropriate exposure. For instance, an average luminance of the entire image is determined for each of the input images IM[1] to IM[P_{A}], and a relatively lower priority order is assigned to an input image having abnormally high or low average luminance. More specifically, for example, a priority order of an input image having an average luminance that is a predetermined high decision luminance Y_{TH1} or higher is set lower than a priority order of other input image. Alternatively, for example, a priority order of an input image having an average luminance that is a predetermined low decision luminance Y_{TH2} or lower is set lower than a priority order of other input image. The high decision luminance Y_{TH1} is a threshold value for distinguishing whether or not the average luminance is abnormally high, and the low decision luminance Y_{TH2} is a threshold value for distinguishing whether or not the average luminance is abnormally low. Y_{TH1}>Y_{TH2} holds.

In addition, a priority order of an input image having a relatively large image area with a so-called whiteout or blackout may be lower than a priority order of an input image having no or almost no such image area and a priority order of an input image having a relatively small such image area. If a luminance signal value of each pixel in a certain image area reaches an upper limit value that the luminance signal value can be or is close to the upper limit value, it is decided that the whiteout has occurred in the image area. If a luminance signal value of each pixel in a certain image area reaches an lower limit value that the luminance signal value can be or is close to the lower limit value, it is decided that the blackout has occurred in the image area.

A necessary computation for setting the priority orders (e.g., computation for calculating the AF score) can be performed in the reproduction mode based on the image data of the input images.

However, as illustrated in FIG. 36, when the imaging apparatus 1 stores the image data of the input image IM[i] in the image file FL[i] in the image sensing mode, the imaging apparatus 1 can store the reference information J[i] in the header region of the image file FL[i] as a part of the additional data of the input image IM[i] (see also FIGS. 2 and 3). The image files of the input images IM[1] to IM[P_{A}] are denoted by symbols FL[1] to FL[P_{A}], respectively, and the reference information for the input images IM[1] to IM[P_{A}] are denoted by symbols J[1] to J[P_{A}], respectively. The body region and the header region in the same image file are associated with each other, the image data of the input image IM[i] and the additional data of the input image IM[i] including the reference information J[i] are naturally associated with each other. The reference information J[i] is data other than the image data of the input image IM[i], which can be used for setting the priority orders.

If the reference information J[1] to J[P_{A}] are stored in the image files FL[1] to FL[P_{A}], the priority order setting unit 52 may determine the priority orders of the input images IM[1] to IM[P_{A}] based on the reference information J[1] to J[P_{A}] read out from the image file FL[1] to FL[P_{A}]. The same is true for other priority order setting methods that will be described later.

In the first priority order setting method, for example, the reference information J[i] is the AF score of the input image IM[i], and the priority orders of the input images IM[1] to IM[P_{A}] may be decided based on the AF scores of the input images IM[1] to IM[P_{A}] as the reference information J[1] to J[P_{A}] read out from the image file FL[1] to FL[P_{A}].

[Second Priority Order Setting Method]

A second priority order setting method will be described. The second priority order setting method is further classified into methods 2_{A}, 2_{B} and 2_{C}.

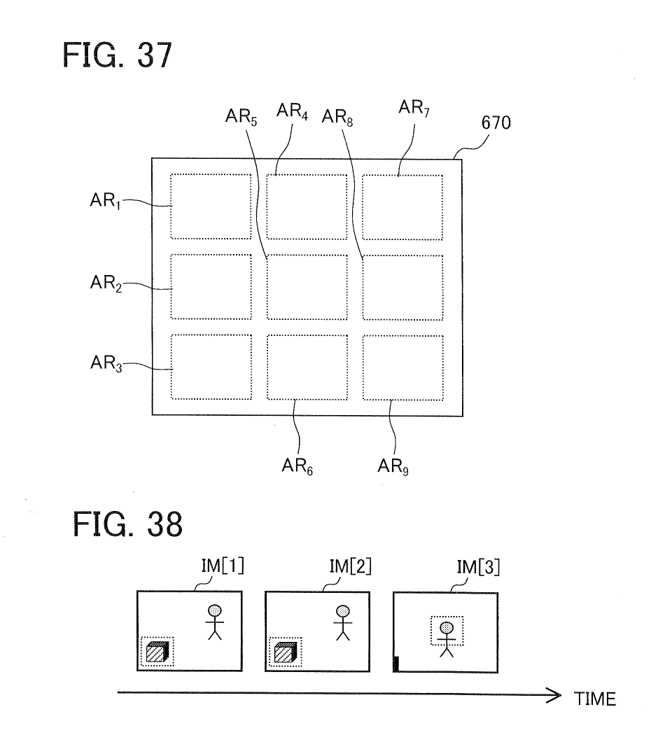

The method 2_{A} will be described. In the method 2_{A}, an in-focus position of each input image is derived first. In order to describe an example of the derivation method, it is supposed that a plurality of decision image areas AR₁ to AR₉ are set with respect to any two-dimensional image 670 as illustrated in FIG. 37. Each of the decision image areas AR₁ to AR₉ is a part of the entire image area of the two-dimensional image 670, and the decision image areas AR₁ to AR₉ are different from each other. Here, the number of the decision image areas is nine, but the number is not limited to nine.

The above-mentioned AF score calculation unit (not shown) calculates the AF score of the decision image area ARⱼ of the input image IM[i] based on the image data in the decision image area ARⱼ of the input image IM[i] (i and j are integers). This calculation is performed for each of the decision image areas. Then, the priority order setting unit 52 specifies the largest AF score among the total nine AF scores determined for the decision image areas AR₁ to AR₉ of the input image IM[i], and detects the decision image area corresponding to the largest AF score as the in-focus region. In addition, the priority order setting unit 52 detects a position of the in-focus region in the input image IM[i] as the in-focus position. This detection process of the in-focus position is performed for each of the input images IM[1] to IM[P_{A}]. Then, if the in-focus position of the input image IM[P_{A}] of the latest image sensing time is different from the in-focus positions of the input images IM[1] to IM[P_{A}−1], a priority order of the first order is assigned to the input image IM[P_{A}]. In this case, priority orders of the input images IM[1] to IM[P_{A}−1] can be determined by the priority order setting method other than the second priority order setting method.

Supposing P_{A} is three, usefulness of the method 2_{A} will be described with reference to FIG. 38. FIG. 38 illustrates an example of input images IM[1] to IM[3], and the in-focus region is indicated by a broken line frame in each of the input images IM[1] to IM[3]. The user as a photographer pays attention to the person for taking the input image. However, when the first and the second input images IM[1] and IM[2] are taken, the object located before the person becomes in focus because an automatic focus control (hereinafter, referred to as AF control) has worked, and as a result the person is not located in the in-focus region of the input images IM[1] and IM[2]. After that, the user changes the frame composition or the like when the third input image IM[3] is taken, so that the person becomes in focus by the AF control. Thus, the person exists in the in-focus region of the input image IM[3]. Supposing this situation, the in-focus position of the input image IM[3] is usually different from that of the input images IM[1] and IM[2]. In other words, if the in-focus position of the input image IM[3] is different from those of the input images IM[1] and IM[2], there is a high probability that the input images IM[1] and IM[2] are taken images with bad focus and that the input image IM[3] is a taken image with good focus. From this, usefulness of the method 2_{A} can he understood. In other words, according to the method 2_{A}, a high priority order can be assigned to an input image that is estimated to have good focus (i.e., an input image that is more important for the user).

It is possible to store the AF scores determined with respect to the decision image areas AR₁ to AR₉ of the input image IM[i], or the in-focus region or the in-focus position of the input image IM[i] as a part of the reference information J[i] in the image file FL[i] in the image sensing mode, so as to perform the method 2_{A} by using the reference information of the individual input images.

A method 2_{B} will be described. In the method 2_{B}, an average luminance of the entire image is determined for each of the input images IM[1] to IM[P_{A}] based on the image data of the input images IM[1] to IM[P_{A}]. Then, if average luminance values Y_{AVE}[1] to Y_{AVE}[P_{A}−1] determined with respect to the input images IM[1] to IM[P_{A}−1] are substantially different from an average luminance value Y_{AVE}[P_{A}] determined with respect to the input image IM[P_{A}], a priority order of the first order is assigned to the input image IM[P_{A}]. In this case, priority orders of the input images IM[1] to IM[P_{A}−1] can be determined by a priority order setting method other than the second priority order setting method.

More specifically, for example, an average value YY of the average luminance values Y_{AVE}[1] to Y_{A}V_{E}[P_{A}−1] is determined. If a difference between the average value YY and the average luminance value Y_{AVE}[P_{A}] is a predetermined value or larger, a priority order of the first order is assigned to the input image IM[P_{A}]. Alternatively, for example, if a variance of the average luminance values Y_{AVE}[1] to Y_{AVE}[P_{A}−1] is smaller than a predetermined reference variance (i.e., the average luminance values Y_{AVE}[1] to Y_{AVE}[P_{A}−1] are the same order) and if a difference between the average value YY and the average luminance value Y_{AVE}[P_{A}] is a predetermined value or larger, a priority order of the first order may be assigned to the input image IM[P_{A}].

The usefulness of the method 2_{B} is similar to the usefulness of the method 2_{A}. If the average luminance of the input image IM[P_{A}] is largely different from those of the input images IM[1] to IM[P_{A}−1], there is a high probability that the input images IM[1] to IM[P_{A}−1] are taken images with wrong exposure adjustment and that the input image IM[P_{A}] is a taken image with correct exposure adjustment (it is estimated that the user as a photographer has repeated the image sensing of input images in similar frame compositions until the taken image with correct exposure adjustment is obtained). According to the method 2_{B}, a high priority order is assigned to the input image IM[P_{A}] in this case. In other words, according to the method 2_{B}, a high priority order can be assigned to an input image that is estimated to be with correct exposure adjustment (i.e., an input image that is more important for the user).

It is possible to store the average luminance Y_{AVE}[i] of the input image IM[i] as a part of the reference information J[i] in the image file FL[i] in the image sensing mode, and to perform the method 2_{B} by using reference information of each input image.

A method 2_{C} will be described. In the method 2_{C}, if a white balance of the input image IM[P_{A}] is largely different from those of the input images IM[1] to IM[P_{A}−1], a priority order of the first order is assigned to the input image IM[P_{A}].

Specifically, for example, the following process can be performed. Concerning the input image IM[i], an R signal average value R_{AVE}[i] of the entire image, G signal average value G_{AVE}[i] of the entire image, and a B signal average value B_{AVE}[i] of the entire image are calculated. This calculation operation is performed for each of the input images IM[1] to IM[P_{A}]. Further, an average value RR of R_{AVE}[1] to R_{AVE}[P_{A}−1], an average value GG of G_{AVE}[1] to G_{AVE}[P_{A}−1], and an average value BB of B_{AVE}[1] to B_{AVE}[P_{A}−1] are determined.

Then, for example, it is decided whether or not the following conditions are satisfied, which are a condition C_{RR} that a difference between the average value RR and R_{AVE}[P_{A}] is a predetermined value or larger, a condition C_{GU} that a difference between the average value GG and G_{AVE}[P_{A}] is a predetermined value or larger, and a condition C_{BB} that a difference between the average value BB and B_{AVE}[P_{A}] is a predetermined value or larger. Further, it is possible to decide whether or not the following conditions are satisfied, which are a condition Rσ that a variance of R_{AVE}[1] to R_{AVE}[P_{A}−1] is smaller than a predetermined reference variance, a condition Gσ that a variance of G_{AVE}[1] to G_{AVE}[P_{A}−1] is smaller than a predetermined reference variance, and a condition Ba that a variance of B_{AVE}[1] to B_{AVE}[P_{A}−1] is smaller than a predetermined reference variance.

Then, if one or more of the conditions C_{RR}, C_{GG} and C_{BB} are satisfied, a priority order of the first order is assigned to the input image IM[P_{A}]. Alternatively, it is possible to assign a priority order of the first order to the input image IM[P_{A}] only if all the conditions C_{RR}, C_{GG} and C_{BB} are satisfied. However, it is possible to determine whether or not to perform the above-mentioned setting further based on whether or not the conditions Rσ, Gσ and Bσ are satisfied.

The usefulness of the method 2_{C} is similar to the usefulness of the methods 2_{A} and 2_{B}. If one or more of the conditions C_{RR}, C_{GG} and C_{BB} are satisfied, or if all the conditions C_{RR}, C_{GG} and C_{BB} are satisfied, it can be said that a color state of the input image IM[P_{A}] is largely different from those of the input images IM[1] to IM[P_{A}−1]. If the color state of the input image IM[P_{A}] is largely different from those of the input images IM[1] to IM[P_{A}−1], for example, it can be estimated that there is a high probability that the input images IM[1] to IM[P_{A}−1] are taken images with wrong white balance adjustment, and that the input image IM[P_{A}] is a taken image with correct white balance adjustment (it is estimated that the user as a photographer has repeated the image sensing of input images in similar frame compositions until the taken image with correct white balance adjustment is obtained). According to the method 2_{C}, in this case, a high priority order is assigned to the input image IM[P_{A}]. In other words, according to the method 2_{C}, a high priority order can be assigned to an input image that is estimated to be with correct white balance adjustment (i.e., an input image that is more important for the user).

It is possible to store the information necessary for deciding whether or not the conditions C_{RR}, C_{GG} and C_{BB}, and the conditions Rσ, Gσ and Bσ are satisfied (e.g., the average value R_{AVE}[i] or the like) as a part of the reference information J[i] in the image file FL[i] in the image sensing mode, so as to perform the method 2_{C} by using the reference information of the individual input images.

[Third Priority Order Setting Method]

A third priority order setting method will be described. Prior to description of the third priority order setting method, a configuration of the image sensing unit 11 illustrated in FIG. 1, and the AF control, an AE control, an AWB control and an automatic scene decision control that the imaging apparatus 1 can perform in the image sensing mode will be described.

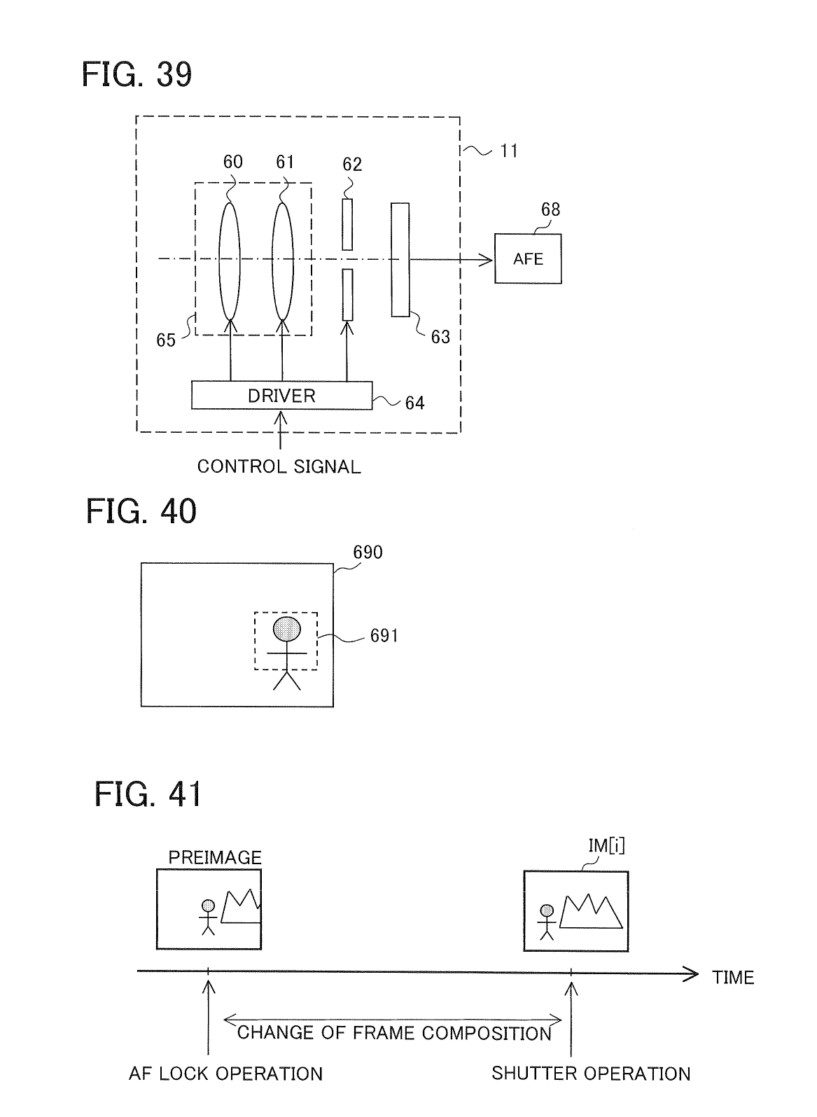

FIG. 39 illustrates analog front end (AFE) 68 disposed between the image sensing unit 11 and the image memory 12 illustrated in FIG. 1, as well as an inside structure of the image sensing unit 11. The image sensing unit 11 includes an optical system 65, an aperture stop 62, an image sensor 63 constituted of a charge coupled device (CCD), a complementary metal oxide semiconductor (CMOS) image sensor or the like, and a driver 64 for controlling drive of the optical system 65 and the aperture stop 62. The optical system 65 is constituted of a plurality of lenses including a zoom lens 60 and a focus lens 61. The zoom lens 60 and the focus lens 61 can be moved in the optical axis direction. The driver 64 controls positions of the zoom lens 60 and the focus lens 61, and an opening degree of the aperture stop 62 (i.e., an aperture stop value) based on a control signal from the image sensing control unit 13 illustrated in FIG. 1, so that a focal length (angle of view) and a focal position of the image sensing unit 11, and an incident light amount to the image sensor 63 are controlled. AFE 68 amplifies an analog signal output from the image sensor 63 and converts the amplified signal into a digital signal, and the obtained digital signal is delivered to the image memory 12.

When the image data of the input image IM[i] is obtained in the image sensing mode, the image sensing control unit 13 can perform the AF control. For specified description, it is supposed that AF control using a through the lens (TTL) type contrast detection method is adopted. Then, in the AF control for the input image IM[i], the following process is performed, for example.

In the image sensing mode, the image sensing control unit 13 or the image analysis unit 14 detects a main subject based on the image data of the frame image 690 (see FIG. 40) that is taken before the input image IM[i], and sets the image area 691 where the main subject is positioned as an AF decision region so as to calculate the AF score of the AF decision region. For instance, among subjects positioned in an image sensing range of the imaging apparatus 1, a subject having the shortest subject distance can be dealt with the main subject. The subject distance means a distance between the imaging apparatus 1 and the subject in the real space. The AF decision region is a part of the entire image area of the frame image 690 and any one of the decision image areas AR₁ to AR₉ in the frame image 690, for example (see FIG. 37). In the AF control, the image sensing control unit 13 adjusts a position of the focus lens 61 so that the AF score of the AF decision region is maximized, and fixes the position of the focus lens 61 at the position where the AF score of the AF decision region is maximized (hereinafter referred to as an AF control lens position) when the AF control is finished. When the input image IM[i] is obtained by using the AF control, the focus lens 61 is positioned at the AF control lens position, and in this state the image data of the input image IM[i] is obtained. Note that the AF control may be performed by using a distance measuring sensor (not shown) for detecting a subject distance.

In the AE control, the aperture stop value (i.e., an opening degree of the aperture stop 62) and ISO sensitivity are adjusted under control of the image sensing control unit 13 illustrated in FIG. 1 based on the image data of the input image or based on an output of a light measuring sensor (not shown) for detecting luminance of the subject, so that luminance of the input image becomes an appropriate luminance. The ISO sensitivity means a sensitivity defined by International Organization for Standardization (ISO). By adjusting the ISO sensitivity, luminance of the input image (luminance level) can be adjusted. Actually, amplification degree of the signal amplification in the AFE 68 is determined in accordance with the ISO sensitivity. When the input image IM[i] is obtained by using the AE control, the image data of the input image IM[i] is obtained with the aperture stop value and ISO sensitivity adjusted in the AE control.

In the AWB control, contents of white balance correction process (hereinafter, referred to as WB correction process) to be performed on the output signal of the AFE 68 is adjusted so that white balance of the input image becomes an appropriate value, under control of the image sensing control unit 13 or the main control unit 19. When the input image IM[i] is obtained by using the AWB control, the image data of the input image IM[i] is generated by performing the WB correction process adjusted by the AWB control on the output signal of the AFE 68.

The position of the focus lens 61, the aperture stop value, the ISO sensitivity and the contents of the WB correction process when the input image IM[i] is obtained is a type of the image sensing condition of the input image IM[i].

In the automatic scene decision control, an image sensing scene of the input image is decided by selecting from a plurality of enrolled scenes based on the image data of the input image. The decided image sensing scene is referred to as a decided scene. The image sensing control unit 13 sets a part of the image sensing condition based on the decided scene of the input image. If the decided scene is different, the image sensing condition to be set is different as a rule. The image sensing condition of the input image IM[i] that is set based on the decided scene includes a shutter speed in the image sensing of the input image IM[i] (i.e., a length of exposure time of the image sensor 63 for obtaining the image data of the input image IM[i] from the image sensor 63), an aperture stop value in the image sensing of the input image IM[i], an ISO sensitivity in the image sensing of the input image IM[i], contents of the image processing to be performed on the output signal of the AFE 68 for generating the input image IM[i], and the like. When the input image IM[i] is obtained by using the automatic scene decision control, the image data of the input image IM[i] is generated in accordance with the image sensing scene and the image sensing condition decided and set by the automatic scene decision control.

Here, the user can perform manually the focus adjustment, the exposure adjustment, the white balance adjustment and the decided scene adjustment without using the AF control, the AE control, the AWB control and the automatic scene decision control. The operation including the operation indicating the adjustments is referred to as a manual adjustment operation. The manual adjustment operation is performed to the operating unit 20 illustrated in FIG. 1. Alternatively, the manual adjustment operation may be realized by the touch panel operation. In this case, the display unit 19 accepting the touch panel operation also works as the operating unit. The manual adjustment operation is an operation for adjusting the image sensing condition of the input image.

For instance, the user can adjust the position of the focus lens 61 by the manual adjustment operation. When this manual adjustment operation is performed on the input image IM[i], the image data of the input image IM[i] is obtained in the state where the position of the focus lens 61 is set to the position adjusted by the manual adjustment operation.

In addition, for example, the user can adjust the aperture stop value and the ISO sensitivity by the manual adjustment operation. If this manual adjustment operation is performed on the input image IM[i], the image data of the input image IM[i] is obtained with the aperture stop value and the ISO sensitivity adjusted by the manual adjustment operation.

In addition, for example, the user can adjust the contents of the WB correction process by the manual adjustment operation. If this manual adjustment operation is performed on the input image IM[i], the image data of the input image IM[i] is obtained with the WB correction process adjusted by the manual adjustment operation.

In addition, for example, the user can specify the decided scene by the manual adjustment operation. If this manual adjustment operation is performed on the input image IM[i], the image data of the input image IM[i] is obtained with the decided scene specified by the manual adjustment operation.

It is preferable that the reference information J[i] includes information indicating whether or not any manual adjustment operation has been performed in the image sensing of the input image IM[i] (the same is true in other priority order setting methods that will be described later). In this way, the priority order setting unit 52 can recognize presence or absence of a manual adjustment operation in the reproduction mode based on the reference information J[i] (the same is true for other priority order setting methods that will be described later).

In the third priority order setting method, the priority order setting unit 52 determines priority orders of the individual input images so that a priority order of an input image obtained with a manual adjustment operation is higher than a priority order of an input image obtained without a manual adjustment operation. Therefore, for example, it is supposed that the user performed image sensing of the input image IM[1] by using the AF control, the AE control, the AWB control and the automatic scene decision control without a manual adjustment operation, and then performed image sensing of the input image IM[2] with the manual adjustment operation for the focus adjustment because the user did not satisfied with the focused state by the AF control, in the image sensing mode. In this case, in the reproduction mode, a priority order of the input image IM[2] is set to be higher than a priority order of the input image IM[1] based on the reference information J[1] and J[2].

It can be said that the input image obtained by the manual focus operation or the like without relying on the automatic control of the imaging apparatus 1 has a higher attention of the user than the input image obtained by the automatic control. Alternatively, it can be said that the former input image is an image in which wrong image sensing in the latter input image is corrected. Considering this, in the third priority order setting method, a higher priority order is assigned to an input image with a manual adjustment operation that is more important for the user.

[Fourth Priority Order Setting Method]

A fourth priority order setting method will be described. In the image sensing mode, the imaging apparatus 1 can obtain frame images sequentially at a predetermined frame period (e.g., 1/60 seconds). For convenience sake, a frame image that is taken after the input image IM[i−1] and before the input image IM[i] is referred to as a preimage.

In the AF control with respect to the input image IM[i], the AF decision region is automatically set in the preimage, and a position of the focus lens 61 (AF control lens position) in which the AF score of the AF decision region is maximized can be searched for based on the image data in the AF decision region of the preimage.

Similarly, in the AE control with respect to the input image IM[i], an AE decision region that is a part or a whole of the entire image area of the preimage is automatically set in the preimage, and the aperture stop value and the ISO sensitivity can be adjusted based on the image data in the AE decision region of the preimage.

Similarly, in the AWB control with respect to the input image IM[i], an AWB decision region that is a part or a whole of the entire image area of the preimage is automatically set in the preimage, and the contents of the WB correction process can be adjusted based on the image data in the AWB decision region of the preimage.

Similarly, in the automatic scene decision control with respect to the input image IM[i], a scene decision region that is a part or a whole of the entire image area of the preimage is automatically set in the preimage, and the image sensing scene can be decided based on the image data in the scene decision region of the preimage.

In the AF control, the image sensing control unit 13 or the main control unit 19 can determine a position and a size of the AF decision region in the preimage based on the image data of the preimage, or can determine the same fixedly in advance. Similarly, in the AE control, the AWB control and the automatic scene decision control, the image sensing control unit 13 or the main control unit 19 can determine positions and sizes of the AE decision region, the AWB decision region and the scene decision region in the preimage based on the image data of the preimage, or can determine the same fixedly in advance.

On the other hand, the user can change the positions and the sizes of the AF decision region, the AE decision region, the AWB decision region and the scene decision region determined by the AF control, the AE control, the AWB control and the automatic scene decision control. The operation for instructing this change is also included in the above-mentioned manual adjustment operation, and the image sensing condition of the input image IM[i] is adjusted also by the operation for instructing this change. It is preferable that the reference information J[i] includes information indicating whether or not any manual adjustment operation as been performed in the image sensing of the input image IM[i]. In this way, the priority order setting unit 52 can recognize presence or absence of a manual adjustment operation in the reproduction mode based on the reference information J[i].

In the fourth priority order setting method, the priority order setting unit 52 determines priority orders of the individual input images so that a priority order of an input image obtained with a manual adjustment operation about the above-mentioned change is higher than a priority order of an input image obtained without a manual adjustment operation about the above-mentioned change. In other words, for example, in the image sensing mode, it is supposed that the user performed image sensing of the input image IM[1] by using the AF control without the manual adjustment operation, and then performed image sensing of the input image IM[2] with the manual adjustment operation for changing the position of the AF decision region used in the AF control because the user did not satisfied with the position. In this case, in the reproduction mode, a priority order of the input image IM[2] is set to be higher than a priority order of the input image IM[1] based on the reference information J[1] and J[2].

It can be said that the input image obtained by manually specifying the AF decision region or the like without relying on the automatic control of the imaging apparatus 1 has a higher attention of the user than the input image obtained by the automatic control. Alternatively, it can be said that the former input image is an image in which wrong image sensing in the latter input image is corrected. Considering this, in the fourth priority order setting method, a higher priority order is assigned to an input image with a manual adjustment operation that is more important for the user.

[Fifth Priority Order Setting Method]

A fifth priority order setting method will be described. The image sensing condition that can be adjusted or set by the AF control, the AE control, the AWB control and the automatic scene decision control can be changed from time to time depending on a frame composition and a state of the subject. On the other hand, the user as a photographer may want to maintain the image sensing condition that is once adjusted or set and to change the frame composition for image sensing of the input image.

For instance, the following operation is often performed by an photographer. If the AF evaluation region as a distance measuring region is positioned at the middle portion of the preimage, as illustrated in FIG. 41, the photographer makes the imaging apparatus 1 perform the AF control with a frame composition in which a person to be focused is positioned in the middle portion of the preimage, and then the photographer performs an AF lock operation for fixing the focused state. After that, the photographer changes the frame composition of the image sensing to a desired frame composition, and performs the shutter operation for obtaining the input image IM[i] (see FIG. 41). In this way, it is possible to obtain an input image having a desired frame composition with a person being focused. Similar operation may be performed for the AE control, the AWB control or the automatic scene decision control, too.

On the other hand, the shutter button 20a illustrated in FIG. 1 support a two-step press down operation. A state of the shutter button 20a with no pressure is referred to as an open state. When the user as a photographer presses the shutter button 20a lightly from the open state, the shutter button 20a becomes a half-pressed state. When the shutter button 20a is further pressed from the half-pressed state, the shutter button 20a becomes a full-pressed state. The shutter operation is an operation of making the shutter button 20a the full-pressed state. In addition, the operation of changing the state of the shutter button 20a from the open state to the half-pressed state can be assigned to the AF lock operation. Similarly, the operation of changing the state of the shutter button 20a from the open state to the half-pressed state can be assigned to an AE lock operation, an AWB lock operation and a scene lock operation. In addition, a special button (not shown) for accepting the AF lock operation, the AE lock operation, the AWB lock operation or the scene lock operation may be disposed in the operating unit 20. In this case, an operation of pressing the special button corresponds to the AF lock operation, the AE lock operation, the AWB lock operation or the scene lock operation.

When the AF lock operation is performed while the AF control is performed, the image sensing control unit 13 fixes the position of the focus lens 61 to the position of the focus lens 61 when the AF lock operation is performed until an AF lock cancellation operation is performed.

When the AF lock operation is performed while the AF control is performed, the image sensing control unit 13 fixes the aperture stop value and the ISO sensitivity to the aperture stop value and the ISO sensitivity when the AE lock operation is performed until an AE lock cancellation operation is performed.

When the AWB lock operation is performed while the AWB control is performed, the image sensing control unit 13 fixes the contents of the WB correction process to be performed on the output signal of the AFE 68 to the contents of the WB correction process when the AWB lock operation is performed until an AWB lock cancellation operation is performed.

When the scene lock operation is performed while the automatic scene decision control is performed, the image sensing control unit 13 fixes the decided scene to the decided scene when the scene lock operation is performed until the scene lock cancellation operation is performed.

The operation of changing the state of the shutter button 20a from the half-pressed state back to the open state can be assigned to the AF lock cancellation operation, the AE lock cancellation operation, the AWB lock cancellation operation and the scene lock cancellation operation.

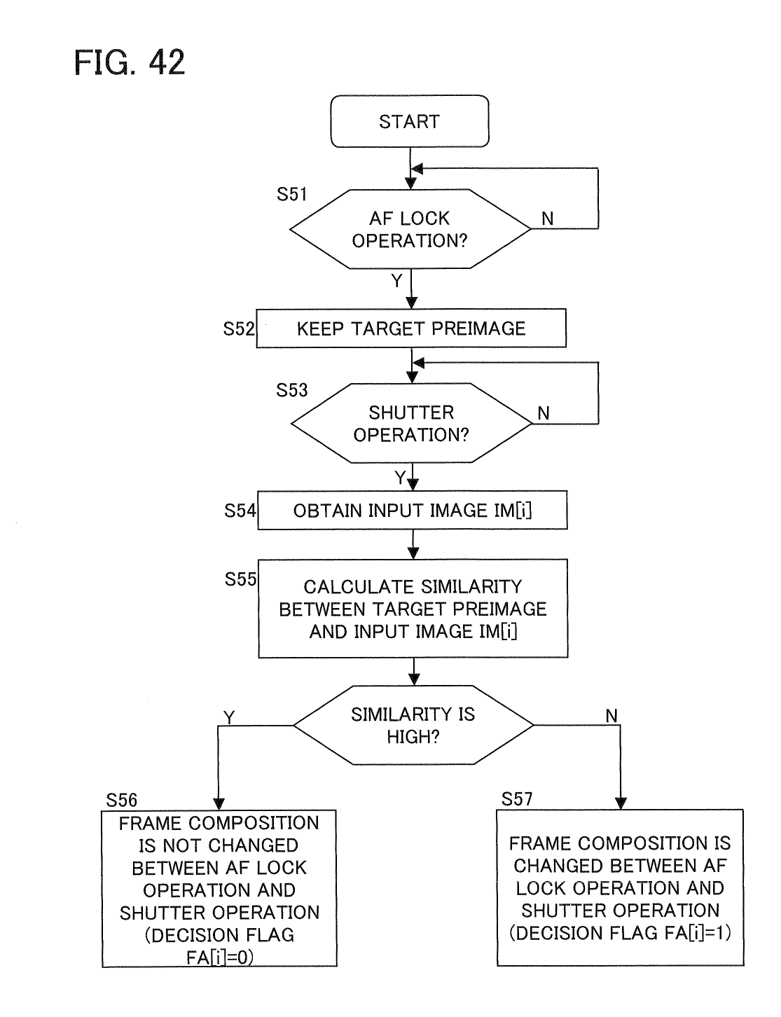

In the image sensing mode, the image analysis unit 14 can decide whether or not the shutter operation is performed on the input image IM[i] after the image sensing frame composition is changed after the AF lock operation, the AE lock operation, the AWB lock operation or the scene lock operation. For specified description, the AF lock operation is noted among the AF lock operation, the AE lock operation, the AWB lock operation and the scene lock operation, and the method of this decision will be described. FIG. 42 is a flowchart illustrating a procedure of the decision method.

When the AF lock operation is performed in the image sensing mode (Step S51), the image analysis unit 14 sets the preimage just before or after the AF lock operation as a target preimage, and the image data of the target preimage is stored (Step S52). After that, if the shutter operation for obtaining the input image IM[i] is performed without the AF lock cancellation operation (Step S53), the image data of the input image IM[i] is obtained (Step S54). The image analysis unit 14 calculates similarity between the images based on the image data of the target preimage and the input image IM[i] (Step S55). Specifically, for example, each of the entire image area of the target preimage and the entire image area of the input image IM[i] is regarded as the characteristic evaluation region, and a characteristic vector of the target preimage and a characteristic vector of the input image IM[i] as well as a distance between these characteristic vectors are calculated in accordance with the method described above in the first embodiment. Here, if the calculated distance is smaller than a predetermined threshold value distance, it is decided that the similarity of the image characteristic between the target preimage and the input image IM[i] is high. Further, it is decided that no change of the image sensing frame composition was performed between the AF lock operation and the shutter operation, and zero is substituted into a decision flag FA[i] (Step S56). On the contrary, if the calculated distance is larger than the above-mentioned threshold value distance, it is decided that the similarity of the image characteristic between the target preimage and the input image IM[i] is low. Further, it is decided that a change of the image sensing frame composition was performed between the AF lock operation and the shutter operation, and one is substituted into the decision flag FA[i] (Step S57). It is also possible to decide whether or not a change of the image sensing frame composition was performed between the AE lock operation and the shutter operation, between the AWB lock operation and the shutter operation, and between the scene lock operation and the shutter operation, in the same manner. When it is decided that a change of the image sensing frame composition was performed between the AE lock operation and the shutter operation, between the AWB lock operation and the shutter operation, or between the scene lock operation and the shutter operation, one is substituted into the decision flag FA[i], too. If such a decision is not made, zero is substituted into the decision flag FA[i].

In addition, the special button (not shown) for accepting the AF lock operation, the AE lock operation, the AWB lock operation or the scene lock operation is disposed in the operating unit 20, one may be substituted into the decision flag FA[i] regardless of a level of the similarity if the shutter operation is performed for the input image IM[i] after the special button is pressed. Zero may be substituted into the decision flag FA[i] regardless of a level of the similarity if the shutter operation is performed for the input image IM[i] without pressing the special button.

The decision flag FA[i] is included in the reference information J[i] and is recorded in the image file FL[i]. The priority order setting unit 52 can recognize whether or not a change of the image sensing frame composition was performed between the AF lock operation, the AE lock operation, the AWB lock operation or the scene lock operation and the shutter operation for the input image IM[i] based on the decision flag FA[i] in the reference information J[i] in the reproduction mode. Alternatively, it is possible to recognize whether or not the above-mentioned special button was pressed before the shutter operation for the input image IM[i].

The priority order setting unit 52 can determine priority orders of the individual input images based on the recognition result. In other words, the priority orders of the individual input images are determined so that a priority order of an input image having a decision flag of one is higher than a priority order of an input image having a decision flag of zero based on the decision flag FA[1] to FA[P_{A}] in the reference information J[1] to J[P_{A}]. For instance, if FA[1]=0 and FA[2]=1 hold, a priority order of the input image IM[2] is set to be higher than a priority order of the input image IM[1]. It is because that the input image obtained by using a function of the AF lock or the like can be said to be an image obtained by image sensing with a more effort or carefulness and has higher attention of the user than the input image obtained without using such a function.

[Sixth Priority Order Setting Method]

A sixth priority order setting method will be described. Although not illustrated in FIG. 1, the imaging apparatus 1 includes a light emission unit constituted of a xenon tube or a light emission diode, so that flash light generated by the light emission unit is projected to the subject as necessary. The user can selectively specify an automatic light emission mode in which the main control unit 21 determines to generate or not the flash light in accordance with luminance of the subject when the image sensing of the input image is performed, or a forced light emission mode in which the flash light is forced to irradiate the subject regardless of luminance of the subject when the image sensing of the input image is performed.

The operation of selecting the forced light emission mode is also included in the manual adjustment operation, the image sensing condition of the input image IM[i] about the flash light is adjusted also by the operation of selecting the forced light emission mode. It is preferable that the reference information J[i] includes information indicating whether or not any manual adjustment operation (the operation of selecting the forced light emission mode in this example) was performed when the image sensing of the input image IM[i] is performed. In this way, the priority order setting unit 52 can recognize presence or absence of the manual adjustment operation based on the reference information J[i] in the reproduction mode.

In the sixth priority order setting method, the priority order setting unit 52 determines priority orders of the individual input images so that a priority order of an input image obtained with the manual adjustment operation about selection of the forced light emission mode is higher than a priority order of an input image obtained without the manual adjustment operation about the selection. In other words, for example, it is supposed that image sensing of the input image IM[1] was performed with the automatic light emission mode in the image sensing mode, and the flash light was not generated in the image sensing of the input image IM[1]. If the user was not satisfied with the luminance of the subject in the input image IM[1], the user may perform the manual adjustment operation of selecting the forced light emission mode and then performs image sensing of the input image IM[2]. In this case, in the reproduction mode, a priority order of the input image IM[2] is set to be higher than a priority order of the input image IM[1] based on the reference information J[1] and J[2].

The input image obtained by manually specifying the forced light emission mode without relying on the automatic light emission control of the imaging apparatus 1 can be said to have a higher attention of the user than the input image obtained with the automatic light emission control. Alternatively, it can be said that the former input image is an image in which wrong image sensing in the latter input image is corrected. Considering this, in the sixth priority order setting method, a higher priority order is assigned to an input image with a manual adjustment operation that is more important for the user.

[Seventh Priority Order Setting Method]

A seventh priority order setting method will be described. The imaging apparatus 1 has a camera shake correction function. The camera shake means a shake of a body of the imaging apparatus 1. If the camera shake correction function is enabled when the image sensing of the input image IM[i] is performed, a blur of the input image IM[i] due to the camera shake can be reduced by an optical or an electronic method. On the other hand, if the camera shake correction function is disabled when the image sensing of the input image IM[i] is performed, such a process for reducing a blur is not performed. The user can specify enabling or disabling of the camera shake correction function by a manual adjustment operation.

In addition, the imaging apparatus 1 has a noise reduction function (hereinafter, referred to as NR function). If the NR function is enabled when the image sensing of the input image IM[i] is performed, the noise reduction process for reducing noise is performed on the output signal of the AFE 68 to be a base of the image data of the input image IM[i], so that the image data after the noise reduction process is generated as the image data of the input image IM[i]. If the NR function is disabled when the image sensing of the input image IM[i] is performed, the image data of the input image IM[i] is generated from the output signal of the AFE 68 without performing such a noise reduction process. The user can specify enabling or disabling of the NR function by a manual adjustment operation.

It is preferable that the reference information J[i] includes contents of the manual adjustment operation for specifying enabling or disabling of the camera shake correction function on the input image IM[i]. It is preferable that the reference information J[i] includes contents of the manual adjustment operation for specifying enabling or disabling of the NR function on the input image IM[i]. In this way, the priority order setting unit 52 can recognize presence or absence of the manual adjustment operation about the camera shake correction function and the NR function based on the reference information J[i] in the reproduction mode.

If image sensing of an input image is performed with the camera shake correction function being disabled, and then image sensing of another input image is performed with the camera shake correction function being enabled, the priority order setting unit 52 sets a priority order of the latter input image to be higher than a priority order of the former input image. In other words, for example, it is supposed that the user performed image sensing of the input image IM[1] with the camera shake correction function being disabled in the image sensing mode. Then, the user was not satisfied with a blur state of the input image IM[1], so that user performs image sensing of the input image IM[2] after setting the camera shake correction function to be enabled. In this case, in the reproduction mode, a priority order of the input image IM[2] is set to be higher than a priority order of the input image IM[1] based on the reference information J[1] and J[2].

Similarly, if image sensing of an input image is performed with the NR function being disabled, and then image sensing of another input image is performed with the NR function being enabled, the priority order setting unit 52 set a priority order of the latter input image to be higher than a priority order of the former input image. In other words, for example, it is supposed that the user performed image sensing of the input image IM[1] with the NR function being disabled in the image sensing mode. Then, the user was not satisfied with a noise state of the input image IM[1], so that the user performs image sensing of the input image IM[2] after setting the NR function to be enabled. In this case, in the reproduction mode, a priority order of the input image IM[2] is set to be higher than a priority order of the input image IM[1] based on the reference information J[1] and J[2].

If image sensing of an input image is performed with the camera shake correction function or the NR function being disabled, and then image sensing of another input image is performed with the same frame composition after setting the camera shake correction function or the NR function to be enabled, there is a high probability that the former input image is an image with low satisfaction for the user, and there is a high probability that the latter input image is an image with higher satisfaction for the user than the former input image. Considering this, in the seventh priority order setting method, a high priority order is assigned to the latter input image that is considered to be more important for the user.

[Eighth Priority Order Setting Method]

An eighth priority order setting method will be described. In the image sensing mode, the user as a photographer can specify the ISO sensitivity in the image sensing of the input image IM[i] by a manual adjustment operation.

It is preferable that the reference information J[i] includes information indicating an ISO sensitivity value of the input image IM[i] and information indicating whether or not the ISO sensitivity of the input image IM[i] is specified by a manual adjustment operation. In this way, the priority order setting unit 52 can recognize the ISO sensitivity value and presence or absence of the manual adjustment operation for specifying the ISO sensitivity based on the reference information J[i] in the reproduction mode.

If image sensing of the input image is performed with the ISO sensitivity being a first ISO sensitivity, and after that, an increase of the ISO sensitivity is specified by the manual adjustment operation, so that another image sensing of the input image is performed with the ISO sensitivity being a second ISO sensitivity, the priority order setting unit 52 sets a priority order of the latter input image to be higher than a priority order of the former input image. Here, the second ISO sensitivity is higher than the first ISO sensitivity. For instance, it is supposed that image sensing of a plurality of input images is performed in a dark place. First, it is supposed that image sensing of the input image IM[1] is performed with a relatively small first ISO sensitivity. If image sensing is performed with a relatively small ISO sensitivity in a dark place, exposure time becomes long so that image blur due to a camera shake is apt to occur in the input image relatively often. Therefore, the user may be not satisfied with the blur state of the input image IM[1]. Then, the user may perform the manual adjustment operation of setting the ISO sensitivity of the input image IM[2] to be the second ISO sensitivity and then may perform image sensing of the input image IM[2]. In this case, the priority order setting unit 52 sets a priority order of the input image IM[2] to be higher than a priority order of the input image IM[1] based on the reference information J[1] and J[2] in the reproduction mode. It is because there is a high probability that the input image IM[2] is an image with higher satisfaction for the user than the input image IM[1].

[Ninth Priority Order Setting Method]

A ninth priority order setting method will be described. The imaging apparatus 1 may include a motion sensor (not shown) which detects a motion of the body of the imaging apparatus 1. The motion sensor is, for example, an angular velocity sensor which detects an angular velocity of the body of the imaging apparatus 1 or an acceleration sensor which detects an acceleration of the body of the imaging apparatus 1. In the image sensing mode, the imaging apparatus 1 can optically reduce blur of the input image IM[i] due to a camera shake by using a detection result of the motion sensor during the exposure period of the input image IM[i]. On the other hand, the record control unit 18 illustrated in FIG. 1 can include the detection result of the motion sensor during exposure period of the input image IM[i] in the reference information J[i].

The priority order setting unit 52 can set a priority order of an input image having a small camera shake during the exposure period to be higher than a priority order of an input image having a large camera shake based on the reference information J[1] to J[P_{A}]. Specifically, for example, the priority order setting unit 52 calculates a body locus length in image sensing of each of the input images IM[1] to IM[P_{A}] based on the reference information J[1] to J[P_{A}]. The body locus length in the image sensing of the input image IM[i] means a total length of a locus along which the body of the imaging apparatus 1 has moved during the exposure period of the input image IM[i]. If the length is large, it can be said that a camera shake in the image sensing of the input image IM[i] is large. Although an influence of the camera shake may be reduced by the optical camera shake correction, the reduction action is not perfect. If the camera shake increases, relatively large blur is apt to remain in the input image. Considering this, for example, if a body locus length of the input image IM[1] is longer than a body locus length of the input image IM[2], the priority order setting unit 52 sets a priority order of the input image IM[2] to be higher than a priority order of the input image IM[1] based on the reference information J[1] and J[2] in the reproduction mode. It is because that the input image IM[2] is considered to be affected by the camera shake less than the input image IM[1].

[Tenth Priority Order Setting Method]

A tenth priority order setting method will be described. In the tenth priority order setting method, the priority order setting unit 52 sets a priority order of an input image that contains image data of a particular type of subject to be higher than a priority order of an input image that does not contain image data of a particular type of subject. The particular type of subject is, for example, a person or an animal (that is considered to be a pet). It is because that the input image that is taken so as to include a person or an animal as a subject is considered to have relatively high importance.

The priority order setting unit 52 can detect whether or not the image data of the input image IM[i] contains image data of a person or an animal by performing the face detection process or an animal detection process on the input image IM[i] based on the image data of the input image IM[i] in the reproduction mode. By performing such a detection process on each of the input images IM[1] to IM[P_{A}], priority orders of the input images IM[1] to IM[P_{A}] can be determined. The animal detection process is a process for detecting whether the image data of the input image contains image data of an animal, and any known method can be used for the detection process. For instance, if the animal is a dog, an enrolled dog image that is an image of dog is prepared in advance. Then, the animal detection process can be realized by using an image matching process or the like based on the image data of the enrolled dog image and the image data of the input image IM[i].

Alternatively, when the image data of the input image IM[i] is stored in the image file FL[i] in the image sensing mode, the image analysis unit 14 or the like illustrated in FIG. 1 may perform the face detection process or the animal detection process is performed on the input image IM[i] based on the image data of the input image IM[i], and may include a result of the process in the reference information J[i] so as to be stored in the image file FL[i]. Then, in the reproduction mode, priority orders of the input images IM[1] to IM[P_{A}] can be determined based on the reference information J[1] to J[P_{A}].

[Eleventh Priority Order Setting Method]

An eleventh priority order setting method will be described. As a type of reproduction mode, there is an image edit mode for editing the input image IM[i] stored in the image file FL[i]. In the image edit mode, the user can edit the image data of the input image IM[i] variously. The edit of the image data of the input image IM[i] includes, for example, changing overall luminance or color of the input image IM[i], or superimposing an illustration on the input image IM[i].

If such an edit is performed on the input image IM[i], the record control unit 18 illustrated in FIG. 1 can overwrite the image data of the edited input image IM[i] on the body region of the image file FL[i] so as to store the same (see FIG. 2). In addition, the record control unit 18 can substitute one into an edit flag FB[i] indicating that the edit is performed. The edit flag FB[i] is included in the reference information J[i]. An initial value of the edit flag FB[i] is zero. Therefore, if the edit is not performed on the input image IM[i], zero is substituted into the edit flag FB[i].

The priority order setting unit 52 can determine priority orders of the individual input images so that a priority order of an input image having the edit flag of one to be higher than a priority order of an input image having the edit flag of zero based on the edit flags FB[1] to FB[P_{A}] in the reference information J[1] to J[P_{A}] in the reproduction mode. For instance, if FB[1]0 and FB[2]=1 hold, a priority order of the input image IM[2] is set to be higher than a priority order of the input image IM[1]. It is because that the edited input image can be considered to be more important for the user. Note that the edit of the input image may be performed by electronic equipment other than the imaging apparatus 1 (e.g., an image reproducing apparatus that is not shown).

[Twelfth Priority Order Setting Method]

Other than that, priority orders may be determined based on various indexes. For instance, the priority orders may be determined based on image sensing time of each input image based on time stamp information of each input image (see FIG. 3).

Note that, as described above in the fourth embodiment, reproduction medium of the m input images may not be the display screen 19a but may be, for example, a paper sheet. If the reproduction medium is a paper sheet, the imaging apparatus 1 is connected to a printer that is not shown, and the layout generation unit 53 illustrated in FIG. 24 sends the reproduction signal to the printer so that a desired print is performed.

In addition, as described above in the fifth embodiment, the above-mentioned individual processes based on the record data in the recording medium 17 may be performed by electronic equipment different from the imaging apparatus (e.g., the image reproducing apparatus that is not shown) (the imaging apparatus is a type of the electronic equipment). For instance, the imaging apparatus 1 obtains the m input images by the image sensing, and image file storing the image data of the input images and the above-mentioned additional data is recorded in the recording medium 17. Further, a reproduction control unit constituted of the image classification unit 51, the priority order setting unit 52 and the layout generation unit 53 illustrated in FIG. 24 is disposed in the electronic equipment. Then, the reproduction by the display or the reproduction by the print according to the sixth embodiment can be realized by supplying the record data in the recording medium 17 to the reproduction control unit in the electronic equipment. Note that a display unit that is similar to the display unit 19 may be disposed in the electronic equipment, or an image analysis unit that is similar to the image analysis unit 14 may be disposed in the electronic equipment as necessary.

### Variations

Specific values shown in the description described above are merely examples, which can be changed to be various values as a matter of course. As variation examples or annotations of the embodiments described above, Note 1 to Note 5 are described below. Contents described in the individual notes can be combined in any manner, as long as no contradiction arises.

[Note 1]

In each embodiment described above, the characteristic vector information, the person presence/absence information and the person ID information is generated and stored in the recording medium 17 in the image sensing operation, and the information is read out so as to evaluate the first to the third similarity in the reproduction operation. However, the information may be generated in the reproduction operation. In other words, in the reproduction mode, the face detection process, the face recognition process and the characteristic vector derivation process may be performed on the input images based on the image data of the input images read out from the recording medium 17, so as to evaluate the first to the third similarities between different input images based on a result of the above-mentioned processes.

[Note 2]

In the thumbnail display mode of the first and the second embodiments, examples where nine thumbnails are displayed simultaneously on the display screen 19a. However, the number of thumbnails displayed simultaneously on the display screen 19a may be other number than nine.

[Note 3]

In the individual embodiments described above, as specific description of an operation of the slide show mode or the like with reproduction objects of a plurality of output images, it is supposed that n is two or larger for convenience sake. However, n may be one. Therefore, it is possible that the image selection unit 31 illustrated in FIG. 8 selects one output image from the m input images.

[Note 4]

The imaging apparatus 1 illustrated in FIG. 1 may be constituted of hardware or a combination of hardware and software. In particular, functions of the image analysis unit 14 and the reproduction control unit 22 can be realized by only hardware or by only software or by a combination of hardware and software. The entire or a part of these functions may be described as a program, and the program may be executed by a program execution device (e.g., a computer), so that the entire or a part of these functions can be realized.

[Note 5]

For instance, it can be considered as follows. The imaging apparatus 1 includes the image reproducing apparatus. This image reproducing apparatus includes the reproduction control unit 22 and may also include the display unit 19, too. It is also considered that the image reproducing apparatus further includes the image analysis unit 14.

What is claimed is:

1. An image reproducing apparatus comprising a reproduction control unit which selects n out of given m input images as n output images by evaluating similarity among different input images of the m input images, and outputs the n output images onto a reproduction medium (m is an integer of two or larger, n is an integer of one or larger, and m>n holds).

2. An image reproducing apparatus according to claim 1, wherein
the m input images include p input images (p is an integer of two or larger, and m>p holds), and
the reproduction control unit decides whether similarity among the p input images is relatively high or relatively low, and performed the selection so that a part of the p input images are excluded from the n output images when it is decided that the similarity among the p input images is relatively high.

3. An image reproducing apparatus according to claim 1, wherein the reproduction control unit performs the similarity evaluation by using an image characteristic quantity indicating an image characteristic of each of the input images.

4. An image reproducing apparatus according to claim 3, wherein the reproduction control unit performs the similarity evaluation by using further at least one or more pieces of information including
information indicating a result of a detection process of detecting whether or not a person is included in each of the input images,
information indicating a result of a recognition process of recognizing a person included in each of the input images,
information indicating generation time of each of the input images, and
information indicating a generation position of each of the input images.

5. An image reproducing apparatus according to claim 1, wherein
n is two or larger, and
the n output images are output onto a display screen or paper as the reproduction medium sequentially q by q (q is an integer of one or larger, and n>q holds), or
the n output images are output onto a display screen or paper as the reproduction medium simultaneously.

6. An imaging apparatus comprising the image reproducing apparatus according to claim 1, wherein the m input images for the image reproducing apparatus are obtained by image sensing.

7. An image reproducing apparatus comprising:
an image classification unit which classifies given m input images into a plurality of categories by evaluating similarity among different input images of the m input images (m is an integer of two or larger);
a priority order setting unit which performs a priority order setting process of setting priority orders of a plurality of input images when the plurality of input images belong to the same category; and
an image output unit which outputs the m input images onto the reproduction medium in accordance with the priority orders set by performing the priority order setting process for each of the categories.

8. An image reproducing apparatus according to claim 7, wherein the priority order setting unit sets the priority orders based on the image data of each of the input image.

9. An image reproducing apparatus according to claim 7, wherein the priority order setting unit sets the priority orders based on additional data associated with each of the input images.

10. An image reproducing apparatus according to claim 7, wherein the m input images are output onto a display screen or paper as the reproduction medium simultaneously or in a plurality of times in accordance with the set priority orders.

11. An imaging apparatus comprising the image reproducing apparatus according to claim 7, wherein the m input images for the image reproducing apparatus are obtained by image sensing.

12. An imaging apparatus according to claim 11, comprising an operating unit which accepts a manual adjustment operation for adjusting an image sensing condition of each of the input images, and the priority order setting unit sets the priority orders based on whether or not the manual adjustment operation has been performed in image sensing of each of the input images.
